(19) United States
(12) Patent Application Publication
(10) Pub. No.: US 2026/0291679 A1
(43) Pub. Date: Sep. 24, 2026

(54) METHOD FOR CONTROLLING MOBILITY OF UE AND APPARATUS THEREOF

(71) Applicant: KT CORPORATION, Gyeonggi-do (KR)

(72) Inventor: Sung Pyo HONG, Gyeonggi-do (KR)

(73) Assignee: KT CORPORATION, Gyeonggi-do (KR)

(21) Appl. No.: 19/577,295

(22) Filed: Mar. 24, 2026

(30) Foreign Application Priority Data
Mar. 24, 2025 (KR) 10-2025-0037377
Mar. 18, 2026 (KR) 10-2026-0048356

(51) Int. Cl. H04L 5/00

(52) U.S. Cl. CPC H04L 5/0048

(57) ABSTRACT

Provided are a method and an apparatus for a UE to perform a mobility operation, the method comprising: receiving, from a base station, an RRC message including semi-persistent CSI-RS resource set information; configuring the semi-persistent CSI-RS resource set for one or more candidate cells; and receiving a MAC CE indicating whether to activate an L1/L2 triggered mobility (LTM) CSI resource configuration including the semi-persistent CSI-RS resource set.

### CROSS-REFERENCE TO RELATED APPLICATION

This application claims priority from Korean Patent Application Nos. 10-2025-0037377, filed on Mar. 24, 2025, and 10-2026-0048356, filed on Mar. 18, 2026, which are hereby incorporated by reference for all purposes as if fully set forth herein.

### BACKGROUND

### Field

The present disclosure relates to a technology regarding a mobility control operation of a UE in an L1/L2 triggered mobility (LTM) procedure.

### Description of Related Art

In a mobile communication system, handover may frequently occur according to movement of a UE. In particular, handover may frequently occur when a user located in a high speed mobile-object, such as a train, a car, and an airplane, uses the mobile communication system.

In the case of typical L3-based handover, a long time is required for a UE to perform procedures required for performing a handover operation to a target base station. There is a concern that the problem may make it difficult to satisfy required quality of service as high-speed movement of a UE requiring low latency increase.

To address the problem, a need for mobility control of a UE triggered in a lower layer (L1/L2) has emerged.

### SUMMARY

The present disclosure is intended to provide a technology for a mobility control operation of a UE in an L1/L2 triggered mobility procedure.

In accordance with an embodiment, a method may be provided for performing a mobility operation by a UE. The method may include: receiving, from a base station, an RRC message including semi-persistent CSI-RS resource set information; configuring the semi-persistent CSI-RS resource set for one or more candidate cells; and receiving a MAC CE indicating whether to activate an L1/L2 triggered mobility (LTM) CSI resource configuration including the semi-persistent CSI-RS resource set.

In accordance with another embodiment, a method may be provided for controlling a mobility operation of a UE by a base station. The method may include: transmitting, to the UE, an RRC message including semi-persistent CSI-RS resource set information; and transmitting a MAC CE indicating whether to activate an L1/L2 triggered mobility (LTM) CSI resource configuration including the semi-persistent CSI-RS resource set for one or more candidate cells configured in the UE.

In accordance with further another embodiment, a UE may be provided for performing a mobility operation. The UE may include: a receiver configured to receive, from a base station, an RRC message including semi-persistent CSI-RS resource set information; and a controller configured to configure the semi-persistent CSI-RS resource set for one or more candidate cells, wherein the receiver is configured to receive a MAC CE indicating whether to activate an L1/L2 triggered mobility (LTM) CSI resource configuration including the semi-persistent CSI-RS resource set.

In accordance with still another aspect, a base station may be provided for controlling a mobility operation of a UE. The base station may include: a transmitter configured to transmit, to the UE, an RRC message including semi-persistent CSI-RS resource set information, and to transmit a MAC CE indicating whether to activate an L1/L2 triggered mobility (LTM) CSI resource configuration including the semi-persistent CSI-RS resource set for one or more candidate cells configured in the UE; and a controller configured to control operations of the transmitter and a receiver.

According to the embodiments, a technology for a mobility control operation of a UE in an L1/L2 trigger-based mobility procedure may be provided.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view schematically illustrating an NR wireless communication system in accordance with embodiments of the present disclosure;

FIG. 2 is a view schematically illustrating a frame structure in an NR system in accordance with embodiments of the present disclosure.

FIG. 3 is a view for explaining resource grids supported by a radio access technology in accordance with embodiments of the present disclosure;

FIG. 4 is a view for explaining bandwidth parts supported by a radio access technology in accordance with embodiments of the present disclosure;

FIG. 5 is a view illustrating an example of a synchronization signal block in a radio access technology in accordance with embodiments of the present disclosure;

FIG. 6 is a signal diagram for explaining a random access procedure in a radio access technology in accordance with embodiments of the present disclosure;

FIG. 7 is a view for explaining CORESET;

FIG. 8 is a flowchart for explaining an operation of a UE according to an embodiment;

FIG. 9 is a flowchart for explaining an operation of a base station according to an embodiment;

FIG. 10 is a view exemplarily illustrating a MAC CE according to an embodiment;

FIG. 11 is a block diagram illustrating a UE according to an embodiment;

FIG. 12 is a block diagram illustrating a base station according to an embodiment.

### DETAILED DESCRIPTION

Hereinafter, some embodiments of the present disclosure will be described in detail with reference to the accompanying illustrative drawings. In the drawings, like reference numerals are used to denote like elements throughout the drawings, even if they are shown on different drawings. Further, in the following description of the present disclosure, a detailed description of known functions and configurations incorporated herein will be omitted when it may make the subject matter of the present disclosure rather unclear. When the expression “include”, “have”, “comprise”, or the like as mentioned herein is used, any other part may be added unless the expression “only” is used. When an element is expressed in the singular, the element may cover the plural form unless a special mention is explicitly made of the element.

In addition, terms, such as first, second, A, B, (A), (B) or the like may be used herein when describing components of the present disclosure. Each of these terminologies is not used to define an essence, order or sequence of a corresponding component but used merely to distinguish the corresponding component from other component(s).

In describing the positional relationship between components, if two or more components are described as being “connected”, “combined”, or “coupled” to each other, it should be understood that two or more components may be directly “connected”, “combined”, or “coupled” to each other, and that two or more components may be “connected”, “combined”, or “coupled” to each other with another component “interposed” therebetween. In this case, another component may be included in at least one of the two or more components that are “connected”, “combined”, or “coupled” to each other.

In the description of a sequence of operating methods or manufacturing methods, for example, the expressions using “after”, “subsequent to”, “next”, “before”, and the like may also encompass the case in which operations or processes are performed discontinuously unless “immediately” or “directly” is used in the expression.

Numerical values for components or information corresponding thereto (e.g., levels or the like), which are mentioned herein, may be interpreted as including an error range caused by various factors (e.g., process factors, internal or external impacts, noise, etc.) even if an explicit description thereof is not provided.

The wireless communication system in the present specification refers to a system for providing various communication services, such as a voice service and a data service, using radio resources. The wireless communication system may include a user equipment (UE), a base station, a core network, and the like.

Embodiments disclosed below may be applied to a wireless communication system using various radio access technologies. For example, the embodiments may be applied to various radio access technologies such as code division multiple access (CDMA), frequency division multiple access (FDMA), time division multiple access (TDMA), orthogonal frequency division multiple access (OFDMA), single-carrier frequency division multiple access (SC-FDMA), non-orthogonal multiple access (NOMA), or the like. In addition, the radio access technology may refer to respective generation communication technologies established by various communication organizations, such as 3GPP, 3GPP2, WiFi, Bluetooth, IEEE, ITU, or the like, as well as a specific access technology. For example, CDMA may be implemented as a wireless technology such as universal terrestrial radio access (UTRA) or CDMA2000. TDMA may be implemented as a wireless technology such as global system for mobile communications (GSM)/general packet radio service (GPRS)/enhanced data rates for GSM evolution (EDGE). OFDMA may be implemented as a wireless technology such as IEEE (Institute of Electrical and Electronics Engineers) 802.11 (Wi-Fi), IEEE 802.16 (WiMAX), IEEE 802-20, evolved UTRA (E-UTRA), and the like. IEEE 802.16m is evolution of IEEE 802.16e, which provides backward compatibility with systems based on IEEE 802.16e. UTRA is a part of a universal mobile telecommunications system (UMTS). 3GPP (3rd-generation partnership project) LTE (long-term evolution) is a part of E-UMTS (evolved UMTS) using evolved-UMTS terrestrial radio access (E-UTRA), which adopts OFDMA in a downlink and SC-FDMA in an uplink. As described above, the embodiments may be applied to radio access technologies that have been launched or commercialized, and may be applied to radio access technologies that are being developed or will be developed in the future.

The UE used in the specification must be interpreted as a broad meaning that indicates a device including a wireless communication module that communicates with a base station in a wireless communication system. For example, the UE includes user equipment (UE) in WCDMA, LTE, NR, HSPA, IMT-2020 (5G or New Radio), and the like, a mobile station in GSM, a user terminal (UT), a subscriber station (SS), a wireless device, and the like. In addition, the UE may be a portable user device, such as a smart phone, or may be a vehicle, a device including a wireless communication module in the vehicle, and the like in a V2X communication system according to the usage type thereof. In the case of a machine-type communication (MTC) system, the UE may refer to an MTC terminal, an M2M terminal, or a URLLC terminal, which employs a communication module capable of performing machine-type communication.

A base station or a cell in the present specification refers to an end that communicates with a UE through a network and encompasses various coverage regions such as a Node-B, an evolved Node-B (eNB), a gNode-B, a low-power node (LPN), a sector, a site, various types of antennas, a base transceiver system (BTS), an access point, a point (e.g., a transmission point, a reception point, or a transmission/reception point), a relay node, a megacell, a macrocell, a microcell, a picocell, a femtocell, a remote radio head (RRH), a radio unit (RU), a small cell, and the like. In addition, the cell may be used as a meaning including a bandwidth part (BWP) in the frequency domain. For example, the serving cell may refer to an active BWP of a UE.

The various cells listed above are provided with a base station controlling one or more cells, and the base station may be interpreted as two meanings. The base station may be 1) a device for providing a megacell, a macrocell, a microcell, a picocell, a femtocell, or a small cell in connection with a wireless region, or the base station may be 2) a wireless region itself. In the above description 1), the base station may be the devices controlled by the same entity and providing predetermined wireless regions or all devices interacting with each other and cooperatively configuring a wireless region. For example, the base station may be a point, a transmission/reception point, a transmission point, a reception point, and the like according to the configuration method of the wireless region. In the above description 2), the base station may be the wireless region in which a user equipment (UE) may be enabled to transmit data to and receive data from the other UE or a neighboring base station.

In this specification, the cell may refer to coverage of a signal transmitted from a transmission/reception point, a component carrier having coverage of a signal transmitted from a transmission/reception point (or a transmission point), or a transmission/reception point itself.

An uplink (UL) refers to a scheme of transmitting data from a UE to a base station, and a downlink (DL) refers to a scheme of transmitting data from a base station to a UE. The downlink may mean communication or communication paths from multiple transmission/reception points to a UE, and the uplink may mean communication or communication paths from a UE to multiple transmission/reception points. In the downlink, a transmitter may be a part of the multiple transmission/reception points, and a receiver may be a part of the UE. In addition, in the uplink, the transmitter may be a part of the UE, and the receiver may be a part of the multiple transmission/reception points.

The uplink and downlink transmit and receive control information over a control channel, such as a physical downlink control channel (PDCCH) and a physical uplink control channel (PUCCH). The uplink and downlink transmit and receive data over a data channel such as a physical downlink shared channel (PDSCH) and a physical uplink shared channel (PUSCH). Hereinafter, the transmission and reception of a signal over a channel, such as PUCCH, PUSCH, PDCCH, PDSCH, or the like, may be expressed as “PUCCH, PUSCH, PDCCH, PDSCH, or the like is transmitted and received”.

For the sake of clarity, the following description will focus on 3GPP LTE/LTE-A/NR (New Radio) communication systems, but technical features of the disclosure are not limited to the corresponding communication systems.

The 3GPP has been developing a 5G (5th-Generation) communication technology in order to meet the requirements of a next-generation radio access technology of ITU-R after studying 4G (4th-generation) communication technology. Specifically, 3GPP is developing, as a 5G communication technology, LTE-A pro by improving the LTE-Advanced technology so as to conform to the requirements of ITU-R and a new NR communication technology that is totally different from 4G communication technology. LTE-A pro and NR all refer to the 5G communication technology. Hereinafter, the 5G communication technology will be described on the basis of NR unless a specific communication technology is specified.

Various operating scenarios have been defined in NR in consideration of satellites, automobiles, new verticals, and the like in the typical 4G LTE scenarios so as to support an enhanced mobile broadband (eMBB) scenario in terms of services, a massive machine-type communication (mMTC) scenario in which UEs spread over a broad region at a high UE density, thereby requiring low data rates and asynchronous connections, and an ultra-reliability and low-latency (URLLC) scenario that requires high responsiveness and reliability and supports high-speed mobility.

In order to satisfy such scenarios, NR introduces a wireless communication system employing a new waveform and frame structure technology, a low-latency technology, a super-high frequency band (mmWave) support technology, and a forward compatible provision technology. In particular, the NR system has various technological changes in terms of flexibility in order to provide forward compatibility. The primary technical features of NR will be described below with reference to the drawings.

### <Overview of NR System>

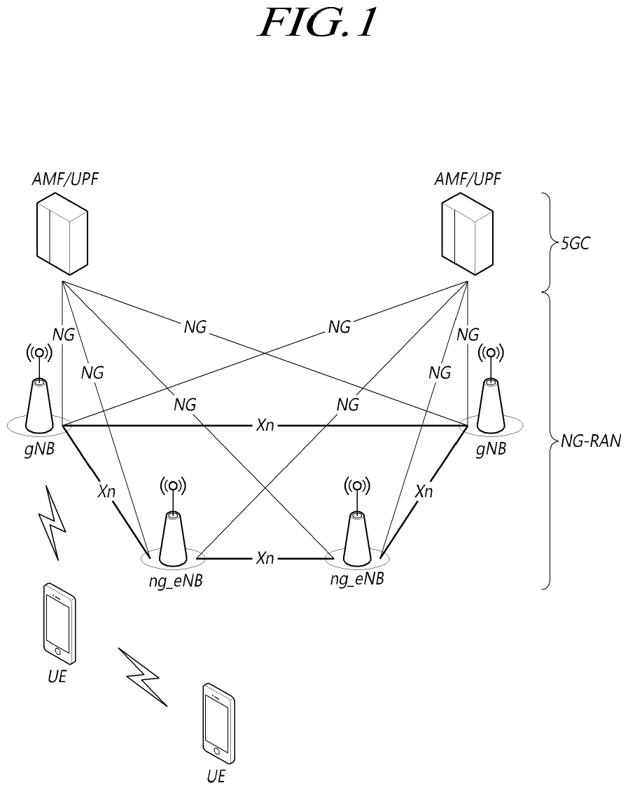

FIG. 1 is a view schematically illustrating an NR system to which the present embodiment is applicable.

Referring to FIG. 1, the NR system is divided into a 5G core network (5GC) and an NG-RAN part. The NG-RAN includes gNBs and ng-eNBs providing user plane (SDAP/PDCP/RLC/MAC/PHY) and user equipment (UE) control plane (RRC) protocol ends. The gNBs or the gNB and the ng-eNB are connected to each other through Xn interfaces. The gNB and the ng-eNB are connected to the 5GC through NG interfaces, respectively. The 5GC may be configured to include an access and mobility management function (AMF) for managing a control plane, such as a UE connection and mobility control function, and a user plane function (UPF) controlling user data. NR supports both frequency bands below 6 GHz (frequency range 1 FR1 FR1) and frequency bands equal to or greater than 6 GHz (frequency range 2 FR2 FR2).

The gNB denotes a base station that provides a UE with an NR user plane and control plane protocol end. The ng-eNB denotes a base station that provides a UE with an E-UTRA user plane and control plane protocol end. The base station described in the present specification should be understood as encompassing the gNB and the ng-eNB. However, the base station may be also used to refer to the gNB or the ng-eNB separately from each other, as necessary.

### <NR Waveform, Numerology, and Frame Structure>

NR uses a CP-OFDM waveform using a cyclic prefix for downlink transmission and uses CP-OFDM or DFT-s-OFDM for uplink transmission. OFDM technology is easy to combine with a multiple-input multiple-output (MIMO) scheme and allows a low-complexity receiver to be used with high frequency efficiency.

Since the three scenarios described above have different requirements for data rates, delay rates, coverage, and the like from each other in NR, it is necessary to efficiently satisfy the requirements for each scenario over frequency bands constituting the NR system. To this end, a technique for efficiently multiplexing radio resources based on a plurality of different numerologies has been proposed.

Specifically, the NR transmission numerology is determined on the basis of subcarrier spacing and a cyclic prefix (CP). As shown in Table 1 below, “μ” is used as an exponential value of 2 so as to be changed exponentially on the basis of 15 kHz.

TABLE 1

| | Subcarrier | | Supported | Supported |
|---|---|---|---|---|
| μ | spacing | Cyclic prefix | for data | for synch |
| 0 | 15 | Normal | Yes | Yes |
| 1 | 30 | Normal | Yes | Yes |
| 2 | 60 | Normal, Extended | Yes | No |
| 3 | 120 | Normal | Yes | Yes |
| 4 | 240 | Normal | No | Yes |

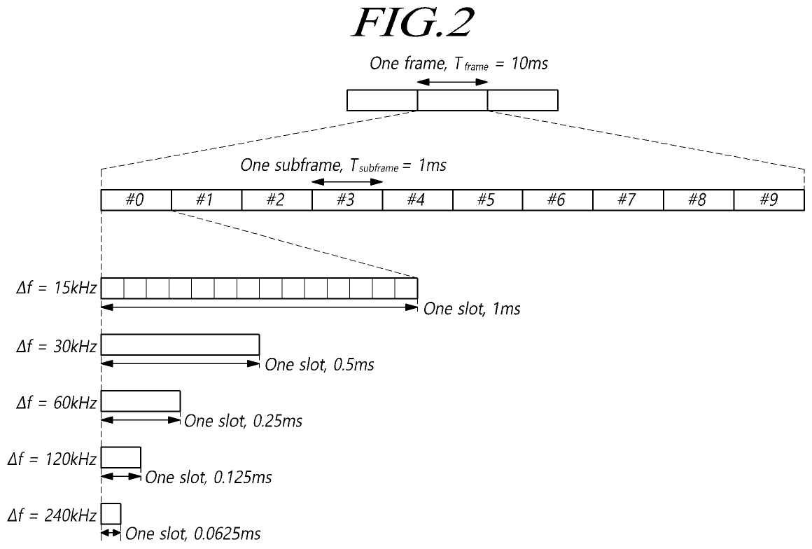

As shown in Table 1 above, NR may have five types of numerologies according to subcarrier spacing. This is different from LTE, which is one of the 4G-communication technologies, in which the subcarrier spacing is fixed to 15 kHz. Specifically, in NR, subcarrier spacing used for data transmission is 15, 30, 60, or 120 kHz, and subcarrier spacing used for synchronization signal transmission is 15, 30, 120, or 240 kHz. In addition, an extended CP is applied only to the subcarrier spacing of 60 kHz. A frame that includes 10 subframes each having the same length of 1 ms and has a length of 10 ms is defined in the frame structure in NR. One frame may be divided into half frames of 5 ms, and each half frame includes 5 subframes. In the case of a subcarrier spacing of 15 kHz, one subframe includes one slot, and each slot includes 14 OFDM symbols. FIG. 2 is a view for explaining a frame structure in an NR system to which the present embodiment may be applied.

Referring to FIG. 2, a slot includes 14 OFDM symbols, which are fixed, in the case of a normal CP, but the length of the slot in the time domain may be varied depending on subcarrier spacing. For example, in the case of a numerology having a subcarrier spacing of 15 kHz, the slot is configured to have the same length of 1 ms as that of the subframe. On the other hand, in the case of a numerology having a subcarrier spacing of 30 kHz, the slot includes 14 OFDM symbols, but one subframe may include two slots each having a length of 0.5 ms. That is, the subframe and the frame may be defined using a fixed time length, and the slot may be defined as the number of symbols such that the time length thereof is varied depending on the subcarrier spacing.

NR defines a basic unit of scheduling as a slot and also introduces a minislot (or a subslot or a non-slot-based schedule) in order to reduce a transmission delay of a radio section. If wide subcarrier spacing is used, the length of one slot is shortened in inverse proportion thereto, thereby reducing a transmission delay in the radio section. A minislot (or subslot) is intended to efficiently support URLLC scenarios, and the minislot may be scheduled in 2, 4, or 7 symbol units.

In addition, unlike LTE, NR defines uplink and downlink resource allocation as a symbol level in one slot. In order to reduce a HARQ delay, the slot structure capable of directly transmitting HARQ ACK/NACK in a transmission slot has been defined. Such a slot structure is referred to as a “self-contained structure”, which will be described.

NR was designed to support a total of 256 slot formats, and 62 slot formats thereof are used in 3GPP Rel-15. In addition, NR supports a common frame structure constituting an FDD or TDD frame through combinations of various slots. For example, NR supports i) a slot structure in which all symbols of a slot are configured for a downlink, ii) a slot structure in which all symbols are configured for an uplink, and iii) a slot structure in which downlink symbols and uplink symbols are mixed. In addition, NR supports data transmission that is scheduled to be distributed to one or more slots. Accordingly, the base station may inform the UE of whether the slot is a downlink slot, an uplink slot, or a flexible slot using a slot format indicator (SFI). The base station may inform a slot format by instructing, using the SFI, the index of a table configured through UE-specific RRC signaling. Further, the base station may dynamically instruct the slot format through downlink control information (DCI) or may statically or quasi-statically instruct the same through RRC signaling.

### <Physical Resources of NR>

With regard to physical resources in NR, antenna ports, resource grids, resource elements, resource blocks, bandwidth parts, and the like are taken into consideration.

The antenna port is defined to infer a channel carrying a symbol on an antenna port from the other channel carrying another symbol on the same antenna port. If large-scale properties of a channel carrying a symbol on an antenna port can be inferred from the other channel carrying a symbol on another antenna port, the two antenna ports may have a quasi-co-located or quasi-co-location (QC/QCL) relationship. The large-scale properties include at least one of delay spread, Doppler spread, a frequency shift, an average received power, and a received timing.

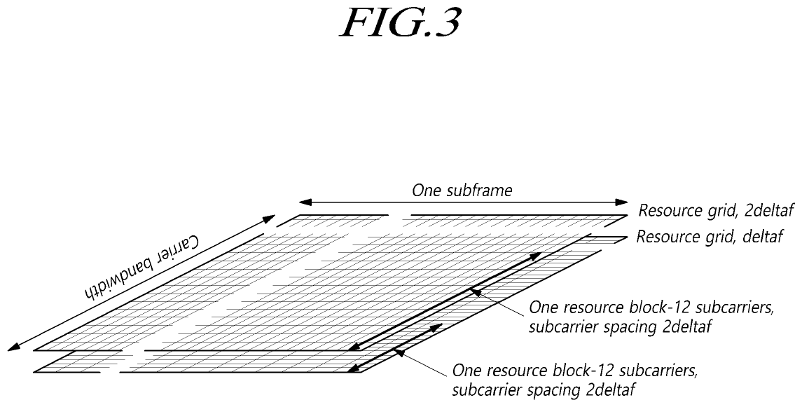

FIG. 3 illustrates resource grids supported by a radio access technology in accordance with embodiments of the present disclosure.

Referring to FIG. 3, resource grids may exist according to respective numerologies because NR supports a plurality of numerologies in the same carrier. In addition, the resource grids may exist depending on antenna ports, subcarrier spacing, and transmission directions.

A resource block includes 12 subcarriers and is defined only in the frequency domain. In addition, a resource element includes one OFDM symbol and one subcarrier. Therefore, as shown in FIG. 3, the size of one resource block may be varied according to the subcarrier spacing. Further, “Point A” that acts as a common reference point for the resource block grids, a common resource block, and a virtual resource block are defined in NR.

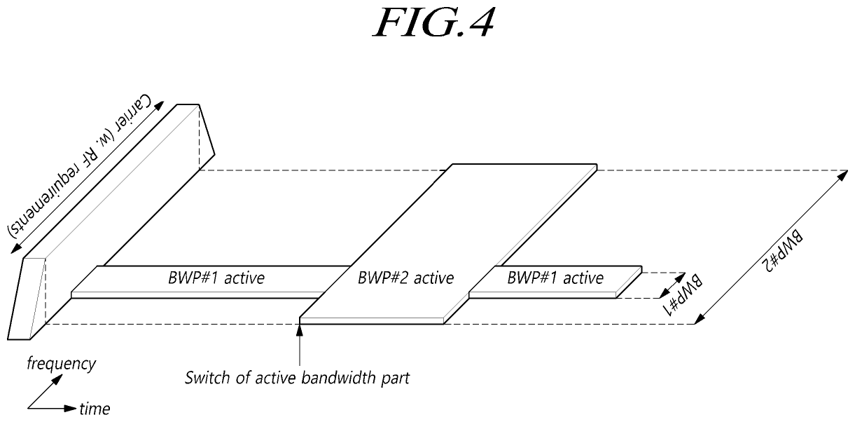

FIG. 4 illustrates bandwidth parts supported by a radio access technology in accordance with embodiments of the present disclosure.

Unlike LTE in which the carrier bandwidth is fixed to 20 MHz, the maximum carrier bandwidth is configured as 50 MHz to 400 MHz depending on the subcarrier spacing in NR. Therefore, it is not assumed that all UEs use the entire carrier bandwidth. Accordingly, as shown in FIG. 4, bandwidth parts (BWPs) may be specified within the carrier bandwidth in NR so that the UE may use the same. In addition, the bandwidth part may be associated with one numerology, may include a subset of consecutive common resource blocks, and may be activated dynamically over time. The UE has up to four bandwidth parts in each of the uplink and the downlink. The UE transmits and receives data using an activated bandwidth part during a given time.

In the case of a paired spectrum, uplink and downlink bandwidth parts are configured independently. In the case of an unpaired spectrum, in order to prevent unnecessary frequency re-tuning between a downlink operation and an uplink operation, the downlink bandwidth part and the uplink bandwidth part are configured in pairs to share a center frequency.

### <Initial Access in NR>

In NR, a UE performs a cell search and a random access procedure in order to access and communicates with a base station.

The cell search is a procedure of the UE for synchronizing with a cell of a corresponding base station using a synchronization signal block (SSB) transmitted from the base station and acquiring a physical-layer cell ID and system information.

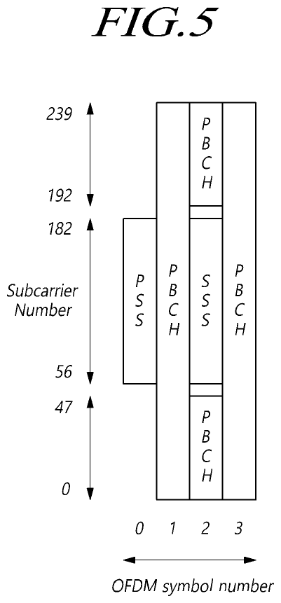

FIG. 5 illustrates an example of a synchronization signal block in a radio access technology in accordance with embodiments of the present disclosure.

Referring to FIG. 5, the SSB includes a primary synchronization signal (PSS) and a secondary synchronization signal (SSS), which occupy one symbol and 127 subcarriers, and PBCHs spanning three OFDM symbols and 240 subcarriers.

The UE monitors the SSB in the time and frequency domain, thereby receiving the SSB.

The SSB may be transmitted up to 64 times for 5 ms. A plurality of SSBs are transmitted by different transmission beams within a time of 5 ms, and the UE performs detection on the assumption that the SSB is transmitted every 20 ms based on a specific beam used for transmission. The number of beams that may be used for SSB transmission within 5 ms may be increased as the frequency band is increased. For example, up to 4 SSB beams may be transmitted at a frequency band of 3 GHz or less, and up to 8 SSB beams may be transmitted at a frequency band of 3 to 6 GHz. In addition, the SSBs may be transmitted using up to 64 different beams at a frequency band of 6 GHz or more.

One slot includes two SSBs, and a start symbol and the number of repetitions in the slot are determined according to subcarrier spacing as follows.

Unlike the SS in the typical LTE system, the SSB is not transmitted at the center frequency of a carrier bandwidth. That is, the SSB may also be transmitted at the frequency other than the center of the system band, and a plurality of SSBs may be transmitted in the frequency domain in the case of supporting a broadband operation. Accordingly, the UE monitors the SSB using a synchronization raster, which is a candidate frequency position for monitoring the SSB. A carrier raster and a synchronization raster, which are the center frequency position information of the channel for the initial connection, were newly defined in NR, and the synchronization raster may support a fast SSB search of the UE because the frequency spacing thereof is configured to be wider than that of the carrier raster.

The UE may acquire an MIB over the PBCH of the SSB. The MIB (master information block) includes minimum information for the UE to receive remaining minimum system information (RMSI) broadcast by the network. In addition, the PBCH may include information on the position of the first DM-RS symbol in the time domain, information for the UE to monitor SIB1 (e.g., SIB1 numerology information, information related to SIB1 CORESET, search space information, PDCCH-related parameter information, etc.), offset information between the common resource block and the SSB (the position of an absolute SSB in the carrier is transmitted via SIB1), and the like. The SIB1 numerology information is also applied to some messages used in the random access procedure for the UE to access the base station after completing the cell search procedure. For example, the numerology information of SIB1 may be applied to at least one of the messages 1 to 4 for the random access procedure.

The above-mentioned RMSI may mean SIB1 (system information block 1), and SIB1 is broadcast periodically (e.g., 160 ms) in the cell. SIB1 includes information necessary for the UE to perform the initial random access procedure, and SIB1 is periodically transmitted over a PDSCH. In order to receive SIB1, the UE must receive numerology information used for the SIB1 transmission and the CORESET (control resource set) information used for scheduling of SIB1 over a PBCH. The UE identifies scheduling information for SIB1 using SI-RNTI in the CORESET. The UE acquires SIB1 on the PDSCH according to scheduling information. The remaining SIBs other than SIB1 may be periodically transmitted, or the remaining SIBs may be transmitted according to the request of the UE.

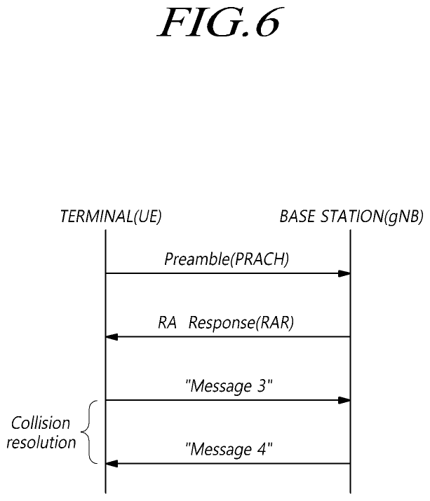

FIG. 6 is a view for explaining a random access procedure in a radio access technology to which the present embodiment is applicable.

Referring to FIG. 6, if a cell search is completed, the UE transmits a random access preamble for random access to the base station. The random access preamble is transmitted over a PRACH. Specifically, the random access preamble is periodically transmitted to the base station over the PRACH that includes consecutive radio resources in a specific slot repeated. In general, a contention-based random access procedure is performed when the UE makes initial access to a cell, and a non-contention-based random access procedure is performed when the UE performs random access for beam failure recovery (BFR).

The UE receives a random access response to the transmitted random access preamble. The random access response may include a random access preamble identifier (ID), UL Grant (uplink radio resource), a temporary C-RNTI (temporary cell-radio network temporary identifier), and a TAC (time alignment command). Since one random access response may include random access response information for one or more UEs, the random access preamble identifier may be included in order to indicate the UE for which the included UL Grant, temporary C-RNTI, and TAC are valid. The random access preamble identifier may be an identifier of the random access preamble received by the base station. The TAC may be included as information for the UE to adjust uplink synchronization. The random access response may be indicated by a random access identifier on the PDCCH, i.e., a random access-radio network temporary identifier (RA-RNTI).

Upon receiving a valid random access response, the UE processes information included in the random access response and performs scheduled transmission to the base station. For example, the UE applies the TAC and stores the temporary C-RNTI. In addition, the UE transmits, to the base station, data stored in the buffer of the UE or newly generated data using the UL Grant. In this case, information for identifying the UE must be included in the data.

Lastly, the UE receives a downlink message to resolve the contention.

### <NR CORESET>

The downlink control channel in NR is transmitted in a CORESET (control resource set) having a length of 1 to 3 symbols, and the downlink control channel transmits uplink/downlink scheduling information, an SFI (slot format index), TPC (transmit power control) information, and the like.

As described above, NR has introduced the concept of CORESET in order to secure the flexibility of a system. The CORESET (control resource set) refers to a time-frequency resource for a downlink control signal. The UE may decode a control channel candidate using one or more search spaces in the CORESET time-frequency resource. CORESET-specific QCL (quasi-colocation) assumption is configured and is used for the purpose of providing information on the characteristics of analogue beam directions, as well as delay spread, Doppler spread, Doppler shift, and an average delay, which are the characteristics assumed by existing QCL.

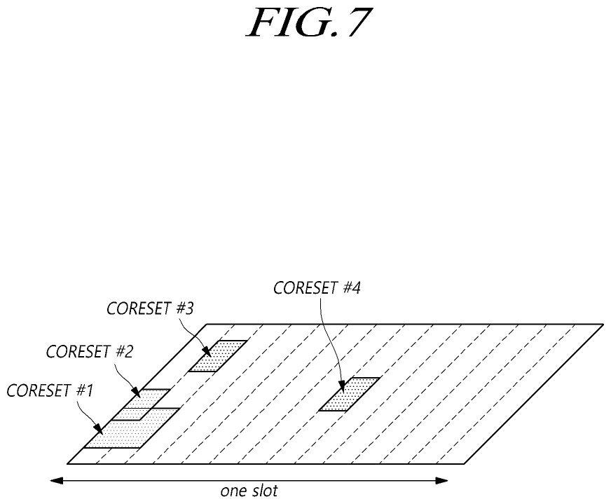

FIG. 7 illustrates CORESET.

Referring to FIG. 7, CORESETs may exist in various forms within a carrier bandwidth in a single slot, and the CORESET may include a maximum of 3 OFDM symbols in the time domain. In addition, the CORESET is defined as a multiple of six resource blocks up to the carrier bandwidth in the frequency domain.

A first CORESET, as a portion of the initial bandwidth part, is designated (e.g., instructed, assigned) through an MIB in order to receive additional configuration information and system information from a network. After establishing a connection with the base station, the UE may receive and configure one or more pieces of CORESET information through RRC signaling.

In this specification, a frequency, a frame, a subframe, a resource, a resource block, a region, a band, a subband, a control channel, a data channel, a synchronization signal, various reference signals, various signals, or various messages in relation to NR (New Radio) may be interpreted as meanings used at present or in the past or as various meanings to be used in the future.

### LTM (L1/L2 Triggered Mobility)

Standardization has been conducted in 3GPP for an L1/L2 triggered mobility (hereinafter referred to as LTM) function in Rel-18. LTM according to the related art is a procedure in which a base station (gNB) receives an L1 measurement report from a UE and changes a serving cell (e.g., PCell/PSCell) of the UE by a cell switch command signaled through a MAC CE based the L1 measurement report. The cell switch command indicates an LTM candidate configuration prepared in advance by the gNB and provided to the UE by the gNB through RRC signaling. Thereafter, the UE switches to a target cell according to the cell switch command.

In LTM, overhead for L1 measurement and reporting based on the L1 measurement and reporting for one or more candidate cells may be large. A base station may need periodic L1 beam level measurement/reporting and/or frequent L1 event-triggered L1 beam level measurement/reporting to select candidate beams and cells for early synchronization and/or to select candidate beams and cells for an LTM cell switch procedure. In particular, LTM technology supports subsequent LTM. Subsequent LTM refers to a procedure in which the UE performs an LTM cell switch without a candidate configuration needing to be reconfigured by a network. For example, the subsequent LTM refers to performing an LTM cell switch to another candidate cell without reconfiguration of the candidate cell/configuration through an RRC reconfiguration message. Subsequent LTM may be performed by repeating early synchronization, LTM execution, and LTM completion steps without releasing other LTM candidate configurations after each LTM completion. For reference, the LTM procedure is divided into an LTM preparation stage of preparing an LTM candidate configuration, an early synchronization stage, an LTM cell switch execution stage, and an LTM cell switch completion stage. However, according to the characteristics of LTM, overhead due to L1 beam level measurement and reporting by different beams within one or more candidate cells may be significant.

Such a typical LTM has a problem of large overhead for L1 measurement and reporting due to the L1 measurement and reporting in the process of supporting the LTM procedure.

The present disclosure, devised to solve the problems, proposes a method and an apparatus for a MAC entity of a UE to reduce L1 beam level measurement and L1 beam level reporting associated with LTM support. The present disclosure provides a method for dynamically controlling L1 measurement and L1 reporting for one or more LTM candidate cells.

Hereinafter, a control method based on 5G NR radio access technology will be described. However, the description is provided for convenience of explanation, and the present disclosure may also be applied to any radio access technology (e.g., 6G). Embodiments described in the present disclosure include information elements, procedures, and operations specified in any NR standard (e.g., TS 38.321 which is a 3GPP NR MAC standard, and TS 38.331 which is a 3GPP NR RRC standard). Even if definitions of corresponding information elements, related procedures, and related UE operations are not described in the present specification, the corresponding contents specified in standard specifications, which are known technologies, may be included in the present disclosure. The embodiments provided below may be implemented individually or by arbitrarily combining/coupling each embodiment (or operations included in the embodiments), and it is obvious that the implementation also belongs to the scope of the present disclosure.

Any function described below may be defined as an individual UE capability (UE radio capability or UE Core network capability) and transmitted by the UE to a base station/core network entity (e.g., AMF/SMF) through corresponding signaling. Alternatively, the functions may be combined/coupled and defined as a corresponding UE capability and transmitted to the base station/core network entity through corresponding signaling at a request of the base station.

The base station may transmit/indicate information indicating permission/support/configuration/activation of a corresponding function/function combination to the UE through an RRC message for any function or any function combination described below. For example, the information may be indicated to the UE before, after, or simultaneously with the configuration/application of the corresponding function/function combination. The RRC message may be broadcast through system information. Alternatively, the information may be indicated to the UE through a dedicated RRC message.

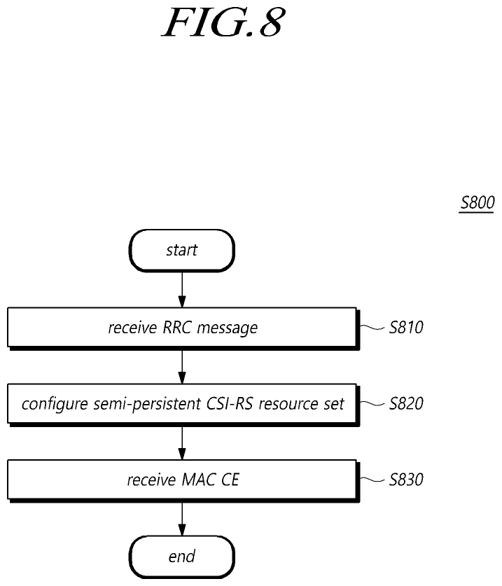

FIG. 8 is a flowchart illustrating a UE operation according to an embodiment.

Referring to FIG. 8, a method S800 performed by a UE for performing a mobility operation may include receiving an RRC message including semi-persistent CSI-RS resource set information from a base station S810.

In accordance with an embodiment, the UE may receive configuration information required to perform an LTM operation through a higher-layer message. For example, the UE may receive LTM configuration information (e.g., LTM-Config) from the base station through an RRC connection reconfiguration message. The UE may store/configure the LTM configuration information in the UE and perform the mobility operation at the low-level described above.

For the LTM operation, the UE may receive semi-persistent CSI-RS resource set information included in the RRC message. As an example, the RRC message may be an RRC connection reconfiguration message, but is not limited thereto.

One or more pieces of semi-persistent CSI-RS resource set information may be included in the RRC message. The semi-persistent CSI-RS resource set information may be configured for each candidate cell for the LTM operation. Alternatively, one or more pieces of semi-persistent CSI-RS resource set information may be configured for each CSI resource. Alternatively, the semi-persistent CSI-RS resource set information may be configured in association with a candidate cell for each CSI-RS resource with respect to one or more CSI-RS resources.

For example, the RRC message may include the LTM configuration information. The LTM configuration information may include several lower-level information elements and may include an LTM CSI resource configuration (LTM CSI ResourceCofing) as one lower-level information element. One or more LTM CSI resource configurations may be included in the LTM configuration information in a list form.

The LTM CSI resource configuration may include at least one of CSI resource configuration identification information, SSB resource set information, or semi-persistent CSI-RS resource set information. Accordingly, one or more pieces of semi-persistent CSI-RS resource set information may be included for each LTM CSI resource configuration. The SSB resource set information may include information on resources related to SSB transmission for channel quality measurement in the corresponding LTM operation. One or more pieces of SSB resource information may be included in the SSB resource set information. The semi-persistent CSI-RS resource set information includes CSI-RS resource information measured by the UE to perform the LTM operation.

CSI resource configuration identification information is identification information allocated for each LTM CSI resource configuration. For example, the CSI resource configuration identification information may refer to ID information, such as a CSI ResourceConfig ID, for distinguishing and recognizing each LTM CSI resource configuration. In addition, the method S800 of performing a mobility operation by a UE may include configuring the semi-persistent CSI-RS resource set for one or more candidate cells S820.

For example, the UE may store information of the received RRC message in the UE and configure parameters for performing an LTM operation. The UE may measure CSI-RS quality for the LTM operation using the configured semi-persistent CSI-RS resource set.

As described above, one or more CSI resource configurations for one or more candidate cells may be configured in the UE. While an LTM operation is performed for fast handover and signal quality maintenance, unnecessary power waste like may occur if the UE measures and determines signal quality for all candidate cells and/or configured CSI resource configurations.

Therefore, when receiving the semi-persistent CSI-RS resource set through an RRC message and configuring the semi-persistent CSI-RS resource set in the UE, the UE may configure the semi-persistent CSI-RS resource set in a deactivated state. By setting the semi-persistent CSI-RS resource set to an activated state only for a target candidate cell while configuring the configurations for the remaining candidate cells in a deactivated state in terms of UE operation, unnecessary signal measurement and monitoring can be prevented.

In addition, the method S800 of performing a mobility operation by a UE may include receiving a MAC CE indicating whether to activate an L1/L2 triggered mobility (LTM) CSI resource configuration including the semi-persistent CSI-RS resource set S830.

The UE receives, from the base station, a MAC CE indicating whether to activate the configured LTM CSI resource configuration. As described above, the LTM CSI resource configuration is configured in the UE in a deactivated state when an RRC message is received. Therefore, in order to activate the LTM CSI resource configuration configured in the UE, the UE may receive indication information from the base station. Alternatively, only one LTM CSI resource configuration or only one semi-persistent CSI resource set information may be configured in an activated state upon initial configuration, and the remaining resource configuration or resource set information may be configured in a deactivated state.

Therefore, the UE may subsequently perform an activation or deactivation operation based on the MAC CE transmitted by the base station.

For example, the MAC CE may include at least one of 1-bit A/D field information indicating activation or deactivation, one or more pieces of CSI resource configuration identification information, or TCI state identification information on a TCI state used as a QCL source in the semi-persistent CSI-RS resource set.

An activation unit using a MAC CE may be set in units of LTM CSI resource configurations, rather than being set for each semi-persistent CSI-RS resource set. Therefore, the MAC CE may include a 1-bit A/D field for indicating whether to activate and CSI resource configuration identification information associated with the A/D field. Accordingly, whether to activate for each piece of CSI resource configuration identification information may be indicated by the MAC CE.

In addition, the MAC CE may further include TCI state identification information for indicating a TCI state used as a QCL source in the semi-persistent CSI-RS resource set.

A plurality of semi-persistent CSI-RS resource sets may exist, and in the case of individually indicating the semi-persistent CSI-RS resource sets, there may be problems in terms of channel measurement and MAC CE overhead. In consideration of the above, whether to activate for each LTM CSI resource configuration including one or more semi-persistent CSI-RS resource sets may be indicated.

To this end, the MAC CE may include CSI resource configuration identification information capable of identifying and indicating the LTM CSI resource configuration, and an A/D field may be set corresponding to each piece of CSI resource configuration identification information. Through the A/D field, the base station may indicate activation/deactivation for two or more CSI resource configurations with one MAC CE.

The CSI resource configuration identification information of the MAC CE may be set to be identical to or associated with identification information (e.g., a CSI resource configuration ID) included as a lower-level information element of the LTM CSI resource configuration included in the RRC message.

In particular, since an activation and deactivation operation are performed a semi-persistent operation, a plurality of activation indications may occur, and in the case of indication in units of resource sets according to high-speed movement of the UE, frequent changes or system overhead may become serious.

According to the embodiments, the MAC CE may be used to indicate whether to activate in units of LTM CSI resource configurations. Therefore, the semi-persistent CSI-RS resource set included in the LTM CSI resource configuration may be indirectly indicated.

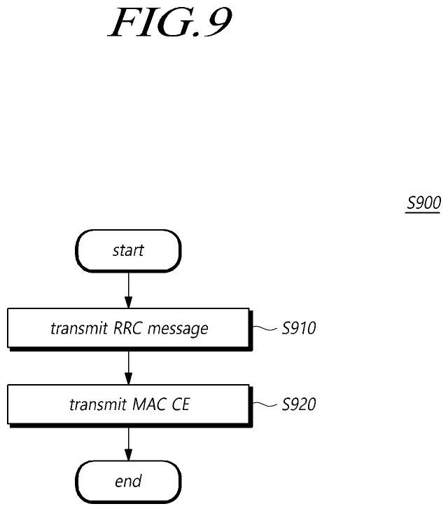

FIG. 9 is a flowchart illustrating a base station operation according to an embodiment.

Referring to FIG. 9, a method S900 performed by a base station for controlling a mobility operation of a UE may include transmitting, to the UE, an RRC message including semi-persistent CSI-RS resource set information S910.

According to an embodiment, the base station may transmit configuration information necessary for performing an LTM operation through a higher layer message. As an example, the base station may transmit LTM configuration information (e.g., LTM-Config) through an RRC connection reconfiguration message. The UE may store/configure the LTM configuration information in the UE and perform the mobility operation described above at a lower level.

For the LTM operation, the base station may transmit semi-persistent CSI-RS resource set information included in the RRC message to the UE. As an example, the RRC message may be an RRC connection reconfiguration message, but is not limited thereto.

One or more pieces of semi-persistent CSI-RS resource set information may be included in the RRC message. In addition, the semi-persistent CSI-RS resource set information may be configured for each candidate cell for the LTM operation. Alternatively, one or more pieces of semi-persistent CSI-RS resource set information may be configured for each CSI resource. Alternatively, the semi-persistent CSI-RS resource set information may be configured in association with a candidate cell for each CSI-RS resource with respect to one or more CSI-RS resources.

According to an embodiment, the RRC message may include the LTM configuration information. The LTM configuration information may include several lower-level information elements and may include an LTM CSI resource configuration (LTM CSI ResourceConfig) as one lower-level information element. One or more LTM CSI resource configurations may be included in the LTM configuration information in a list form.

The LTM CSI resource configuration may include at least one of CSI resource configuration identification information, SSB resource set information, or semi-persistent CSI-RS resource set information. Accordingly, one or more pieces of semi-persistent CSI-RS resource set information may be included for each LTM CSI resource configuration. The SSB resource set information may include information on resources related to SSB transmission for channel quality measurement in the LTM operation. The SSB resource set information may include one or more pieces of SSB resource information. The semi-persistent CSI-RS resource set information includes CSI-RS resource information measured by the UE to perform the LTM operation.

The CSI resource configuration identification information is identification information allocated for each LTM CSI resource configuration. For example, the CSI resource configuration identification information may refer to ID information such as a CSI ResourceConfig ID for identifying and recognizing each LTM CSI resource configuration.

The UE may store information of the received RRC message in the UE and configure parameters for performing the LTM operation. The UE may measure CSI-RS quality for the LTM operation using the configured semi-persistent CSI-RS resource set.

The method S900 of controlling a mobility operation of a UE by a base station may include transmitting a MAC CE indicating whether to activate an L1/L2 triggered mobility (LTM) CSI resource configuration including a semi-persistent CSI-RS resource set for one or more candidate cells configured in the UE S920.

One or more CSI resource configurations may be configured in the UE for one or more candidate cells. An LTM operation is performed for fast handover and signal quality maintenance, but unnecessary power waste may occur if the UE measures and determines signal quality for all candidate cells and/or configured CSI resource configurations.

Accordingly, when the UE receives the semi-persistent CSI-RS resource set through the RRC message and configures the semi-persistent CSI-RS resource set in the UE, the UE may configure the semi-persistent CSI-RS resource set in a deactivated state. In terms of UE operation, unnecessary signal measurement and monitoring can be prevented by setting the semi-persistent CSI-RS resource set to an activated state only for a target candidate cell while configuring configurations for the remaining candidate cells in the deactivated state.

For the operation, the base station transmits, to the UE, a MAC CE indicating whether to activate the LTM CSI resource configuration configured in the UE. The LTM CSI resource configuration is configured in the UE in a deactivated state when the RRC message is received. Therefore, the base station may transmit indication information to the UE to activate the LTM CSI resource configuration configured in the UE. Alternatively, the UE may be configured such that only one LTM CSI resource configuration or one piece of semi-persistent CSI resource set information is configured in an activated state during initial configuration, and the remaining resource configuration or resource set information is configured in a deactivated state. Accordingly, the UE may subsequently perform an activation or deactivation operation based on the MAC CE transmitted by the base station.

For example, the MAC CE may include at least one of 1-bit A/D field information indicating activation or deactivation, one or more pieces of CSI resource configuration identification information, or TCI state identification information on a TCI state used as a QCL source in the semi-persistent CSI-RS resource set.

An activation unit using the MAC CE may be set in units of LTM CSI resource configurations, rather than being set for each semi-persistent CSI-RS resource set. Accordingly, the MAC CE may include a 1-bit A/D field for indicating whether to activate and CSI resource configuration identification information associated with the A/D field. Accordingly, whether to activate for each piece of CSI resource configuration identification information may be indicated by the MAC CE.

In addition, the MAC CE may further include TCI state identification information for indicating a TCI state used as a QCL source in the semi-persistent CSI-RS resource set.

In the case of semi-persistent CSI-RS resource sets, a plurality of sets may exist, and if these are individually indicated, there may be problems in terms of channel measurement and MAC CE overhead. In consideration of the above, whether to activate may be indicated for each LTM CSI resource configuration including one or more semi-persistent CSI-RS resource sets.

For the operation, the MAC CE may include CSI resource configuration identification information that can identify and indicate an LTM CSI resource configuration, and an A/D field may be configured to correspond to each piece of CSI resource configuration identification information. Through the A/D field, the base station may indicate activation/deactivation for two or more CSI resource configurations by one MAC CE.

The CSI resource configuration identification information of the MAC CE may be configured identically to or in association with identification information (e.g., CSI resource configuration ID) included as a lower-level information element of the LTM CSI resource configuration included in an RRC message.

Particularly, since activation and deactivation operations are performed in semi-persistent operation, a plurality of activation indications via MAC CE may occur, and in the case of indication in units of resource sets according to high-speed mobility of the UE, frequent changes or system overhead may become serious.

According to the embodiments described above, the MAC CE may be used to activate in units of LTM CSI resource configurations through the MAC CE. Therefore, the base station may indirectly indicate a semi-persistent CSI-RS resource set included in the LTM CSI resource configuration.

Hereinafter, more specific embodiments that can be performed by the above-described UE and base station and various embodiments for each step will be described. The embodiments below may be combined in any combination and performed by the UE and the base station.

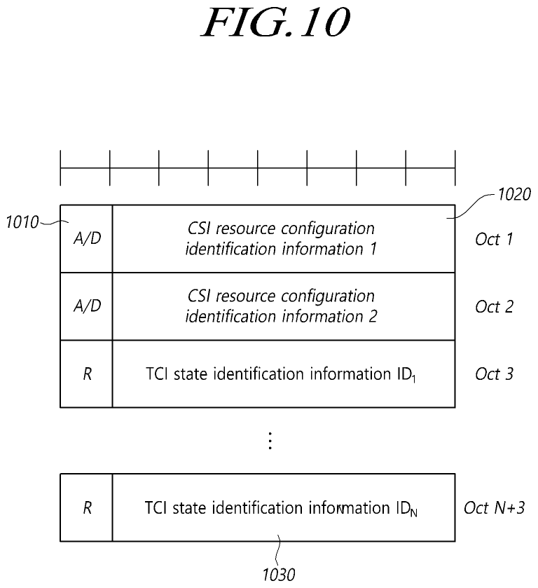

FIG. 10 is a diagram illustrating an example of MAC CE according to an embodiment.

Referring to FIG. 10, the UE receives a MAC CE for indicating activation of an LTM CSI resource configuration. The MAC CE may include a 1-bit A/D field 1010 for indicating whether to activate, CSI resource configuration identification information 1020 associated with the A/D field, and TCI state identification information 1030 on a TCI state used as a QCL source in the semi-persistent CSI-RS resource set.

For example, the A/D field 1010 may be configured to correspond to each piece of CSI resource configuration identification information 1020. Each piece of CSI resource configuration identification information 1020 is information for identifying an LTM CSI resource configuration and may be included as a lower-level information element of the LTM CSI resource configuration. Therefore, each piece of CSI resource configuration identification information 1020 included in the MAC CE corresponds to CSI resource configuration identification information included in the LTM CSI resource configuration.

The A/D field 1010 may indicate whether to activate each corresponding piece of CSI resource configuration identification information 1020 with 1 bit. For example, when a value of the 1 bit is 0 (or 1), the corresponding CSI resource configuration identification information 1020 may indicate a deactivated state.

Meanwhile, the TCI state identification information 1030 may also be included in the MAC CE to correspond to a CSI resource configuration or a semi-persistent CSI-RS resource set according to identification information. The TCI state identification information 1030 represents a TCI state used as a QCL source in the semi-persistent CSI-RS resource set.

The MAC CE structure described above is exemplary, and fields and information included in the MAC SE structure may be added or subtracted according to the embodiments below.

In the following, each embodiment will be described in more detail.

### Method of Activating/Deactivating L1 Measurement for One or More Candidate Cells

As described above, LTM is a procedure in which a base station receives L1/L3 measurement results from a UE and changes a serving cell of the UE by a cell switch command signaled through a MAC CE based on the measurement results. In an LTM preparation step included in the LTM procedure, the base station indicates an RRC reconfiguration message including an LTM configuration (e.g., ltm-Config) to the UE. The UE performs reconfiguration according to a field of the received LTM configuration information element. In an early synchronization step (or before or after the early synchronization step), to select candidate beams and cells for early synchronization and/or to select candidate beams and cells for an LTM cell switch procedure, the UE may perform L1 measurement on configured LTM candidate cells. The UE may transmit an L1 measurement report to a source cell/base station. L1 measurement and/or L1 reporting may be performed while the RRC reconfiguration including the LTM configuration described above is applicable.

Hereinafter, for convenience of explanation, L1 beam-level measurement performed in the LTM procedure is denoted as L1 measurement. In addition, for convenience of explanation, a UCI or MAC CE-based L1 (measurement/measurement result) report/reporting (e.g., UCI-based, LTM L1 report, MAC CE-based LTM L1 measurement report) is denoted as L1 reporting. A measurement configuration for L1 measurement may be included in the LTM configuration. Alternatively, the measurement configuration for L1 measurement may be linked to the LTM configuration. For example, a resource configuration for L1 measurement (e.g., a resource configuration for L1 beam-level measurement for an LTM serving cell or one or more LTM candidate cells (LTM CSI resource configuration)) may be included as a lower-level information element of an LTM configuration including common information for an LTM serving cell/configuration or one or more LTM candidate cells/configurations. An LTM candidate configuration included as a lower-level information element of the LTM configuration may include a reference signal resource (e.g., LTM CSI-RS resource) list and a resource set (e.g., LTM CSI-RS resource set) list for L1 beam-level measurement. A report configuration for L1 reporting may be included in the LTM configuration. Alternatively, the report configuration for L1 reporting may be linked to the LTM configuration. For example, an LTM candidate configuration included as a lower-level information element of the LTM configuration may include a report configuration for L1 reporting (e.g., LTM CSI report configuration).

Hereinafter, an L1 measurement resource/resource set may refer to an SSB/CSI-RS resource/resource set. For convenience of description, even if one specific resource/resource set is described, it is understood that other resources/resource sets are also included in the scope of the present disclosure. For example, any resource/resource set included in the present disclosure may represent a non-zero-power (NZP) CSI-RS resource/resource set. Alternatively, any resource/resource set described herein may represent a zero-power (ZP) CSI-RS resource/resource set. Alternatively, any resource/resource set described herein may represent a periodic resource/resource set. Any resource/resource set described herein may represent a semi-persistent resource/resource set. Any resource/resource set described herein may represent a resource/resource set associated with MAC CE-based measurement reporting for an LTM procedure.

In the LTM procedure, L1 measurement is performed on one or more beams within one or more candidate cells. As the UE moves, the candidate cell for which the L1 measurement is to be performed may change. As the UE moves, the beams within the candidate cell for which the L1 measurement is to be performed may change. In consideration of this, the L1 measurement may be performed dynamically.

As an example, a base station may activate/deactivate a corresponding L1 measurement resource/resource set configured in one or more candidate cells for the one or more candidate cells. For example, a periodic/semi-persistent ZP/NZP CSI-RS resource set configured for the corresponding candidate cell(s) may be activated/deactivated by defining a corresponding MAC CE and transmitting the MAC CE to the UE.

The resource/resource set configuration may be configured in the UE through resource/resource set configuration information associated with the L1 measurement. For example, a reference signal resource set (e.g., LTM-SSB resource set, LTM CSI-RS resource set, LTM CSI-IM resource set) for L1 beam-level measurement may be configured for one or more LTM candidate cells through a resource configuration for L1 measurement (LTM CSI resource configuration) included as a lower-level information element of an LTM configuration. A semi-persistent NZP CSI-RS resource set configuration configured for the corresponding candidate cell(s) may include a list of the NZP CSI-RS resources and a list of candidate configuration identification information of candidate cells associated with the NZP CSI-RS resources. The configured periodic/semi-persistent ZP/NZP CSI-RS resource set may be initially deactivated when the UE receives an RRC reconfiguration message and is configured/reconfigured, and/or after the UE receives an RRC reconfiguration message including reconfiguration with sync (an L3 handover command) and performs an L3 handover (reconfiguration with sync). If an LTM cell change is executed, the corresponding CSI-RS resource set may maintain an activated state for a target cell. However, it may be deactivated for other candidate cells.

When the UE (or a MAC entity of the UE) receives the MAC CE on a serving cell, the UE (or the MAC entity of the UE) may indicate information regarding the MAC CE to a physical layer.

As another example, the base station may activate/deactivate a corresponding L1 measurement sub-resource/resource set configured in one or more candidate cells. For example, a configured periodic/semi-persistent ZP/NZP sub-CSI-RS resource/resource set may be activated/deactivated by defining a corresponding MAC CE and transmitting the MAC CE to the UE.

The base station may activate/deactivate at least one of the configured sub-configurations of a configured periodic/semi-persistent resource/resource set by transmitting the corresponding MAC CE.

The resource/resource set sub-configuration may be configured in the UE through resource/resource set sub-configuration information associated with the L1 measurement. For each periodic/semi-persistent CSI/SSB/CSI-RS resource/resource set configured with the CSI/SSB/CSI-RS resource/resource set sub-configuration information, the base station may deactivate all configured sub-configurations by transmitting the MAC CE. The configured periodic/semi-persistent CSI/SSB/CSI-RS resource/resource set may be initially deactivated when the UE receives an RRC reconfiguration message and is configured/reconfigured, and/or after the UE receives an RRC reconfiguration message including reconfiguration with sync (an L3 handover command) and performs an L3 handover (reconfiguration with sync).

When the UE (or a MAC entity of the UE) receives the MAC CE on a serving cell, the UE (or the MAC entity of the UE) may indicate information regarding the MAC CE to the physical layer.

As another example, the base station may activate/deactivate a corresponding L1 measurement configured in one or more candidate cells. For example, the L1 measurement configured in the candidate cell(s) may be activated/deactivated by defining a corresponding MAC CE and transmitting the MAC CE to the UE.

As another example, a MAC CE may be defined for activation/deactivation of a corresponding L1 measurement in one candidate/serving cell, activation/deactivation of all corresponding L1 measurement resources/resource sets of a corresponding candidate cell for each candidate cell in one or more candidate serving cells, and activation/deactivation of a corresponding L1 reporting of a corresponding candidate cell for each candidate cell in one or more candidate serving cells. The corresponding MAC CE may be defined as different MAC CEs each having a respective LCID.

As another example, a MAC CE for providing one or more of activation/deactivation of: a MAC CE for activation/deactivation of a corresponding L1 measurement in one candidate/serving cell; a MAC CE for activation/deactivation of all corresponding L1 measurement resources/resource sets of a corresponding candidate cell for each candidate cell in one or more candidate serving cells; and a MAC CE for activation/deactivation of a corresponding L1 reporting of a corresponding candidate cell for each candidate cell in one or more candidate serving cells, may be defined.

As another example, the MAC CE may include one or more of: information for indicating whether a CSI/SSB/CSI-RS resource/resource set (and/or sub-CSI/SSB/CSI-RS resource/resource set) for a candidate/serving cell configuration is in an activated/deactivated state (e.g., a 1-bit A/D field); information for identifying a candidate/serving cell to which the corresponding MAC CE is applied (e.g., a 5-bit serving cell id/ServCellIndex, physical cell id); information for identifying a candidate configuration to which the MAC CE is applied (e.g., ltm-CandidateId, Target Configuration ID: ltm-CandidateId−1); a 2-bit DL BWP-ID to which the MAC CE is applied (according to a codepoint of a DCI bandwidth part indicator field); CSI/SSB/CSI-RS resource/resource set (and/or sub-CSI/SSB/CSI-RS resource/resource set) identification information; and a TCI state ID of a TCI state used as a QCL source in a CSI/SSB/CSI-RS resource/resource set (and/or sub-CSI/SSB/CSI-RS resource/resource set) (indicated by the CSI/SSB/CSI-RS resource/resource set (and/or sub-CSI/SSB/CSI-RS resource/resource set) identification information field).

For example, if a resource configuration for L1 measurement (LTM CSI resource configuration) included as a lower-level information element of an LTM configuration indicates a CSI-RS resource set including only CSI-RS resources for one serving/candidate cell, similarly to a CSI-RS resource set included in a general CSI resource configuration (CSI-ResourceConfig), then the CSI-RS resource set configured for the candidate cell may be activated/deactivated on a candidate cell basis by transmitting a MAC CE including information for identifying a candidate configuration associated with the candidate cell and the CSI/SSB/CSI-RS resource set identification information. As another example, if a resource configuration for L1 measurement (LTM CSI resource configuration) included as a lower-level information element of an LTM configuration indicates a CSI-RS resource set including CSI-RS resources included in a plurality of candidate cells (e.g., if one LTM CSI-RS resource set includes CSI-RS resources of one or more candidate cells such that an LTM candidate cell associated with each CSI-RS resource included in the LTM CSI-RS resource set is configured), then the CSI-RS resource set configured for the corresponding candidate cell(s) may be activated/deactivated on a CSI-RS resource basis by transmitting a MAC CE including information for identifying a candidate configuration associated with each candidate cell and CSI-RS resource identification information associated with the candidate cell, up to the number of pieces of CSI-RS resource identification information included in the CSI-RS resource set. Alternatively, the CSI-RS resource set configured for the candidate cell(s) may be activated/deactivated on a candidate cell and/or CSI-RS resource basis by transmitting a MAC CE including information for identifying a candidate configuration associated with each candidate cell and a list of CSI-RS resource set identification information associated with the candidate cells, up to the number of candidate cells included in the CSI-RS resource set.

As another example, the MAC CE may include one or more of: information for indicating whether a CSI/SSB/CSI-RS resource/resource set (and/or sub-CSI/SSB/CSI-RS resource/resource set) for a candidate/serving cell/configuration is in an activated/deactivated state (e.g., a 1-bit A/D field); information for identifying a candidate/serving cell to which the MAC CE is applied (e.g., a 5-bit serving cell id/ServCellIndex, physical cell id); information for identifying a candidate configuration to which the corresponding MAC CE is applied (e.g., ltm-CandidateId, Target Configuration ID: ltm-CandidateId−1); and a 2-bit DL BWP-ID (or UL BWP-ID) to which the corresponding MAC CE is applied according to a codepoint of a DCI bandwidth part indicator field.

As another example, the MAC CE may have a variable size. Through the variable size, activation/deactivation for one or more resources/resource sets may be indicated.

As another example, the MAC CE may be configured to have a fixed size. Through the fixed size, processing overhead in the UE and the base station may be reduced.

As another example, the MAC CE may include one or more pieces of information among: information for indicating whether to activate the L1 measurement for the candidate cell/configuration; a number of CSI/SSB/CSI-RS resources/resource sets included in the MAC CE; information for indicating whether an activation/deactivation state of the CSI/SSB/CSI-RS resource/resource set (and/or sub-CSI/SSB/CSI-RS resource/resource set); information for indicating whether an activation/deactivation state of the CSI/SSB/CSI-RS resource/resource set (and/or sub-CSI/SSB/CSI-RS resource/resource set); information for identifying the CSI/SSB/CSI-RS resource configuration; information for identifying the CSI/SSB/CSI-RS resource set configuration; information for identifying the sub-CSI/SSB/CSI-RS resource configuration; information for identifying the sub-CSI/SSB/CSI-RS resource set configuration; a CSI-RS index (or CSI-RS resource indicator (CRI)); candidate cell/configuration identification information of the CSI/SSB/CSI-RS resource/resource set configuration; associated CSI/SSB/CSI-RS report identification information; event LTM information; a threshold; a serving/candidate cell ID to which the MAC CE is applied; a candidate configuration ID to which the MAC CE is applied; a candidate cell/configuration ID list to which the MAC CE is applied; or a BWP-ID to which the MAC CE is applied. For example, if a resource configuration for L1 measurement (LTM CSI resource configuration) included as a lower-level information element of an LTM configuration indicates a CSI-RS resource set including CSI-RS resources included in a plurality of candidate cells (e.g., if one LTM CSI-RS resource set includes CSI-RS resources of one or more candidate cells such that an associated LTM candidate cell is configured for each CSI-RS resource included in the LTM CSI-RS resource set), the CSI-RS resource set configured for the candidate cell(s) may be activated/deactivated by transmitting a MAC CE including information for identifying the CSI-RS resource configuration configured for the one or more candidate cells.

As another example, the MAC CE may include one or more pieces of information among: information for indicating whether to activate the L1 measurement for the candidate cell/configuration; or identification information for the cell/configuration to which the MAC CE is applied.

An i-th bit of a field for indicating whether to activate the L1 measurement for the candidate cell/configuration may be determined according to an ascending order (or descending order) of configured candidate cell/configuration identification information. For example, a first (e.g., i=0) bit may be for a candidate cell/configuration having a lowest candidate cell/configuration identification information. A second (i=1) bit may be for a candidate cell/configuration having a second lowest candidate cell/configuration identification information. (Alternatively, the first (e.g., i=0) bit may be for a cell/configuration of the serving cell. The second (i=1) bit may be for a candidate cell/configuration having a lowest candidate cell/configuration identification information except for the serving cell.)

If a bit of the field is set to 0, the L1 measurement (or the L1 measurement configuration) of the candidate cell may be deactivated. If the bit of the field is set to 1, the L1 measurement (or the L1 measurement configuration) of the candidate cell may be activated. The field may be (pre-) configured/specified as fixed bits (e.g., 4, 8) less than or equal to 8, considering that a maximum number of LTM candidate configurations is 8. Alternatively, the field may be (pre-) configured/specified as 16 or 32 bits to enable configuration for more cells including SCells in addition to the LTM candidate configuration. Alternatively, a number of bits of the field may be indicated to the base station through the RRC message. Through the number of bits of the field, the base station may be able to configure a number of cells to be included in the MAC CE. Alternatively, the field may be (pre-) configured/specified as a specific fixed value (e.g., 4) shorter than 64 bits. Through the fixed value, overhead for processing can be reduced.

Identification information for the cell/configuration to which the MAC CE is applied may be distinguished through at least one of information for identifying a candidate/serving cell (e.g., 5-bit serving cell ID/ServCellIndex, physical cell ID) or information for identifying a candidate configuration to which the MAC CE is applied (e.g., ltm-CandidateId, Target Configuration ID: ltm-CandidateId−1).

As another example, an information field for indicating whether to activate the L1 measurement for the candidate cell/configuration to which the MAC CE is applied may have a value of a fixed size. If a number of candidate cells/configurations in a candidate cell/configuration list included in an RRC message is less than the fixed value (e.g., i+1), the UE may ignore the i-th bit/field. Through the fixed size, the UE can be prevented from performing an unnecessary operation.

As another example, the MAC CE may include information for indicating whether an activation/deactivation state of the CSI/SSB/CSI-RS resource/resource set (and/or sub-CSI/SSB/CSI-RS resource/resource set). An i-th bit of the field may be determined according to an ascending order (or descending order) of configured resource/resource set identification information (and/or sub-resource/resource set identification information). If a bit of the field is set to 0, the configuration may be deactivated. If the bit of the field is set to 1, the configuration may be activated. The field may be (pre-) configured/specified as a value less than or equal to 112 bits, considering that a maximum number of LTM CSI resource configurations is 112. Alternatively, the field may be (pre-) configured/specified as a value less than or equal to 64 bits, considering that a maximum number of NZP-CSI-RS resource set configurations is 64. Alternatively, a number of bits of the field may be indicated to the base station through the RRC message. Through the number of bits of the field, the base station may be able to configure a number of CSI/SSB/CSI-RS resources/resource sets to be included in the MAC CE. Alternatively, considering a number of beams practically used in one cell, the field may be (pre-) configured/specified as a specific fixed value (e.g., 4, 8, 16) shorter than 64 bits. Through the fixed value, overhead for processing can be reduced.

As another example, the MAC CE may include, for each candidate cell/configuration, information for indicating whether an activation/deactivation state of the CSI/SSB/CSI-RS resource/resource set (and/or sub-CSI/SSB/CSI-RS resource/resource set). An i,j-th bit of the field may be determined according to an ascending order (or descending order) of an i-th configured candidate cell/configuration identification information for i/j, and an ascending order (or descending order) of a j-th configured resource/resource set identification information (and/or sub-resource/resource set identification information). If a bit of the field is set to 0, the configuration may be deactivated. If the bit of the field is set to 1, the configuration may be activated.

The field may be configured as bits having (the maximum number of candidate cells/configurations)*(the maximum number of resource/resource set configurations), considering one or more of a maximum number of LTM candidate cells/configurations, a maximum number of LTM CSI resource configurations, or a maximum number of NZP-CSI-RS resource set configurations. Alternatively, a number of bits of the field may be indicated to the base station through the RRC message. Alternatively, through the number of bits, the base station may be able to configure a number of bits to be included. The number of bits may be indicated through one field/parameter. Alternatively, the number of bits may be indicated through two fields/parameters (a number of cells, a number of resources/resource sets). Alternatively, the field may be (pre-) configured/specified as a short specific fixed value (e.g., 4 for the number of cells, 4/8 for the number of resources/resource sets). Through the fixed value, overhead for processing can be reduced with 16/32 bits.

As another example, the MAC CE may include, in addition to information for indicating whether an activation/deactivation state of the CSI/SSB/CSI-RS resource/resource set (and/or sub-CSI/SSB/CSI-RS resource/resource set) for each candidate cell/configuration, at least one of: identification information for identifying a candidate/serving cell to which the MAC CE is applied (e.g., 5-bit serving cell ID/ServCellIndex, physical cell ID); identification information for identifying a candidate configuration to which the MAC CE is applied (e.g., ltm-CandidateId, Target Configuration ID: ltm-CandidateId−1); a 2-bit DL BWP-ID (or UL BWP-ID) to which the MAC CE is applied according to a codepoint of a DCI bandwidth part indicator field; CSI/SSB/CSI-RS resource/resource set (and/or sub-CSI/SSB/CSI-RS resource/resource set) identification information; or a TCI state ID of a TCI state used as a QCL source in the CSI/SSB/CSI-RS resource/resource set (and/or sub-CSI/SSB/CSI-RS resource/resource set) (indicated by the CSI/SSB/CSI-RS resource/resource set (and/or sub-CSI/SSB/CSI-RS resource/resource set) identification information field).

As another example, the MAC CE may include one or more pieces of information among: information for indicating whether an activation/deactivation state of all CSI/SSB/CSI-RS resources/resource sets (and/or sub-CSI/SSB/CSI-RS resources/resource sets or the L1 measurement, or the L1 measurement/measurement configuration) for the candidate/serving cell/configuration; or information for indicating whether an activation/deactivation state of the CSI/SSB/CSI-RS resource/resource set (and/or sub-CSI/SSB/CSI-RS resource/resource set) for each candidate cell/configuration.

As another example, for the information for indicating whether an activation/deactivation state of all CSI/SSB/CSI-RS resources/resource sets (and/or sub-CSI/SSB/CSI-RS resources/resource sets or the L1 measurement, or the L1 measurement/measurement configuration) for the candidate/serving cell/configuration, an i-th bit of the field may be determined according to an ascending order (or descending order) of configured candidate cell/configuration identification information. For example, a first (e.g., i=0) bit may be for a candidate cell/configuration having a lowest candidate cell/configuration identification information. A second (i=1) bit may be for a candidate cell/configuration having a second lowest candidate cell/configuration identification information. (Alternatively, the first (e.g., i=0) bit may be for a cell/configuration of the serving cell. The second (i=1) bit may be for a candidate cell/configuration having a lowest candidate cell/configuration identification information except for the serving cell.)

As another example, if information for indicating whether an activation/deactivation state of all CSI/SSB/CSI-RS resources/resource sets (and/or sub-CSI/SSB/CSI-RS resources/resource sets or the L1 measurement, or the L1 measurement/measurement configuration) for the candidate/serving cell/configuration has a fixed value (e.g., 4), and a size (e.g., number of bits) of a field for indicating activation/deactivation of a CSI/SSB/CSI-RS resource/resource set (and/or sub-CSI/SSB/CSI-RS resource/resource set) configuration x for a candidate/serving cell/configuration identifier i has a fixed value (e.g., 8), if a bit/field for indicating an activation/deactivation state of the L1 measurement in an i-th candidate/serving cell/configuration is set to activation (e.g., 1), i,x bits/fields, for example, for which x=0, 1, 2, 3, 4, 5, 6, 7, may exist for corresponding i,x bits/fields. If the bit/field for indicating the activation/deactivation state of the L1 measurement in the i-th candidate/serving cell/configuration is set to deactivation (e.g., 0), the i,x bits/fields, for example, for which x=0, 1, 2, 3, 4, 5, 6, 7, may not exist for the corresponding i,x bits/fields. For a deactivated candidate cell/configuration, since all L1 report configurations thereof are also deactivated, the bit/field may not exist.

As another example, if a number of L1 measurements in the candidate cell/configuration list included in the RRC message is less than the fixed value (e.g., x+1), the UE may ignore the corresponding i,x-th bit/field. Through the fixed value, the UE can be prevented from performing an unnecessary operation.

As another example, if a number of L1 measurement sub-configurations in the L1 measurement sub-configuration list included in/associated with the L1 measurement included in the RRC message is less than the fixed value (e.g., x+1), the UE may ignore the corresponding i,x-th bit/field. Through the fixed value, the UE can be prevented from performing an unnecessary operation.

In another example, a corresponding MAC CE may be provided through one or more MAC CEs having different LCIDs/eLCIDs. For example, a MAC CE using 8 bits for information for indicating whether to activate a corresponding L1 measurement for a corresponding candidate cell/configuration, or a MAC CE using 16/32 bits for information for indicating whether to activate a corresponding L1 measurement for a corresponding candidate cell/configuration may be defined and used. Alternatively, a MAC CE using a specific number of bits for information for indicating whether to activate a corresponding L1 measurement for a candidate cell/configuration, or a MAC CE using another specific number of bits for information for indicating whether to activate a corresponding L1 measurement for a candidate cell/configuration may be defined and used. Alternatively, a MAC CE having a specific number of bits for the corresponding number of bits, or a MAC CE having another specific number of bits for the corresponding number of bits may be defined and used. Alternatively, it may include a MAC CE for indicating whether to activate a corresponding L1 measurement for a candidate cell/configuration, and a MAC CE for indicating whether a corresponding CSI/SSB/CSI-RS resource/resource set (and/or sub CSI/SSB/CSI-RS resource/resource set) is in an activated/deactivated state. Alternatively, it may include a MAC CE for indicating whether to activate a corresponding L1 measurement for a candidate cell/configuration, and a MAC CE for indicating whether to activate a corresponding L1 measurement sub-configuration included in/associated with a corresponding L1 measurement configuration for the candidate cell/configuration. Alternatively, it may include a MAC CE for indicating whether to activate a corresponding L1 measurement for one candidate cell/configuration, and a MAC CE for indicating whether to activate a corresponding L1 measurement for one or more candidate cells/configurations.

In another example, a MAC CE may include information for indicating an activation/deactivation state of a CSI/SSB/CSI-RS resource/resource set (and/or sub CSI/SSB/CSI-RS resource/resource set) for each candidate cell/configuration. The i-th and j-th bits of a field may be determined according to an ascending order (or descending order) of the i-th configured candidate cell/configuration identification information for i/j, and an ascending order (or descending order) of the j-th configured resource/resource set identification information (and/or sub-resource/resource set identification information).

### Method for Activating/Deactivating Corresponding L1 Reporting for One or More Candidate Cells

In an LTM procedure, L1 measurement for one or more beams within one or more candidate cells is performed. According to movement of the UE, a candidate cell for which corresponding L1 beam-level measurement result reporting should be performed may be changed. According to movement of the UE, beams within a candidate cell for which the corresponding L1 beam-level measurement result reporting should be performed may be changed. In consideration of this, the corresponding L1 reporting may be dynamically performed.

In one example, a base station may activate/deactivate corresponding L1 reporting configured in one or more candidate cells. For example, a configured L1 report configuration may be activated/deactivated by defining a corresponding MAC CE and transmitting the MAC CE to a UE.

A base station may activate/deactivate at least one of the configured sub-configurations of a configured L1 reporting by transmitting a corresponding MAC CE.

An L1 report configuration/sub-configuration may be configured in a UE through L1 report configuration/sub-configuration information. For each L1 reporting configured with the corresponding L1 report sub-configuration information, a base station may deactivate all configured sub-configurations by transmitting the MAC CE. A configured L1 reporting may be initially deactivated when the UE receives an RRC reconfiguration message and is configured/reconfigured, and/or after the UE receives an RRC reconfiguration message including reconfiguration with sync (L3 handover command) and performs L3 handover (reconfiguration with sync).

When a UE (or a MAC entity of the UE) receives a corresponding MAC CE on a serving cell, the UE (or the MAC entity of the UE) may indicate information regarding the MAC CE to the physical layer.

In another example, a base station may activate/deactivate all corresponding L1 reporting configured in one or more candidate cells. For example, the L1 reporting configured in the candidate cells may be activated/deactivated by defining a corresponding MAC CE and transmitting the MAC CE to a UE.

In another example, a MAC CE for activating/deactivating corresponding L1 reporting in one candidate/serving cell, a MAC CE for activating/deactivating all corresponding L1 reporting of a corresponding candidate cell for each candidate cell in one or more candidate serving cells, and a MAC CE for activating/deactivating corresponding L1 reporting of a corresponding candidate cell for each candidate cell in one or more candidate serving cells may be defined. The corresponding MAC CEs may be defined as different MAC CEs having respective LCIDs.

In another example, a MAC CE for providing one or more of activations/deactivations of: activating/deactivating corresponding L1 reporting in one candidate/serving cell; activating/deactivating all corresponding L1 reporting of a corresponding candidate cell for each candidate cell in one or more candidate serving cells; and activating/deactivating corresponding L1 reporting of a corresponding candidate cell for each candidate cell in one or more candidate serving cells, may be defined.

In another example, a MAC CE may include one or more of: information for identifying a candidate/serving cell to which the MAC CE is applied (e.g., 5-bit serving cell id/ServCellIndex, physical cell id); information for identifying a candidate configuration to which the MAC CE is applied (e.g., ltm-CandidateId, Target Configuration ID: ltm-CandidateId−1); a 2-bit UL BWP-ID/DL BWP-ID to which the MAC CE is applied (according to a codepoint of a DCI bandwidth part indicator field); and information for indicating an activation/deactivation state of a corresponding L1 report in a corresponding L1 report configuration/sub-configuration (e.g., ltm-CSI-ReportConfig, ltm-CSI-subReportConfig) list to which the MAC CE is applied. An information field for indicating an activation/deactivation state of a corresponding L1 report in a corresponding L1 report configuration/sub-configuration list to which the corresponding MAC CE is applied may be configured to have a number of bits less than or equal to 48, considering a maximum number (e.g., 48) of CSI report configurations. The information field may be configured to have a number of bits greater than or equal to 8, considering a maximum number (e.g., 8) of sub-configurations per CSI report configuration. An i-th bit of the corresponding information field may be determined according to an ascending order (or descending order) of corresponding L1 report configuration identification information. For example, a first (e.g., i=0) bit may be for a report configuration having a lowest corresponding L1 report configuration identifier. A second (i=1) bit may be for a report configuration having a second lowest corresponding L1 report configuration identifier. If a bit of the corresponding field is set to 0, the corresponding configuration may be deactivated. If a bit of the corresponding field is set to 1, the corresponding configuration may be activated.

In another example, information for indicating a size (e.g., number of bits) of an information field for indicating an activation/deactivation state of a corresponding L1 report in a corresponding L1 report configuration/sub-configuration list to which the MAC CE is applied may be configured/indicated to a UE by a base station explicitly or implicitly. For example, the information may be transmitted by defining corresponding indication information. Alternatively, the UE may be configured to process the information in consideration of a corresponding L1 report configuration/sub-configuration list included in a corresponding RRC message. Through the size information, the UE can easily process the information considering the size applied in the corresponding L1 report configuration.

In another example, a size (e.g., number of bits) of an information field for indicating an activation/deactivation state of a corresponding L1 report in a corresponding L1 report configuration/sub-configuration list to which a MAC CE is applied may have a fixed value. If the number of corresponding L1 report configurations/sub-configurations (having a corresponding report configuration type (e.g., event trigger condition)) in a corresponding L1 report configuration/sub-configuration list included in an RRC message is less than the fixed value (e.g., i+1), a UE may be configured to ignore the i-th bit/field. Through the fixed value, it is possible to prevent the UE from performing an unnecessary operation.

In another example, an L1 report configuration/sub-configuration to which a MAC CE is applied may be configured to have an event-triggered report type (e.g., report configuration type).

In another example, a MAC CE may include one or more of: information for identifying a candidate/serving cell to which the MAC CE is applied (e.g., 5-bit serving cell id/ServCellIndex, physical cell id); information for identifying a candidate configuration to which the MAC CE is applied (e.g., ltm-CandidateId, Target Configuration ID: ltm-CandidateId−1); a 2-bit UL BWP-ID/DL BWP-ID to which the MAC CE is applied (according to a codepoint of a DCI bandwidth part indicator field); information for indicating an activation/deactivation state of a corresponding L1 report in a corresponding L1 report configuration (e.g., ltm-CSI-ReportConfig) list to which the corresponding MAC CE is applied; and information for indicating activation/deactivation of a sub-configuration x in a corresponding L1 report sub-configuration (e.g., ltm-CSI-subReportConfig) list for a corresponding L1 report configuration identifier i.

As another example, a size (e.g., the number of bits) of an information field for indicating an activation/deactivation state of a corresponding L1 report in a corresponding L1 report configuration (e.g., ltm-CSI-ReportConfig) list to which a MAC CE is applied may have a fixed value (e.g., 4 or 8). A size (e.g., the number of bits) of a field for indicating activation/deactivation of a sub-configuration x in a corresponding L1 report sub-configuration (e.g., ltm-CSI-subReportConfig) list for a corresponding L1 report configuration identifier i may have a fixed value (e.g., 4 or 8).

As another example, at least one of a size (e.g., the number of bits) of an information field for indicating an activation/deactivation state of a corresponding L1 report in a corresponding L1 report configuration (e.g., ltm-CSI-ReportConfig) list to which a MAC CE is applied, or a size (e.g., the number of bits) of a field for indicating activation/deactivation of a sub-configuration x in a corresponding L1 report sub-configuration (e.g., ltm-CSI-subReportConfig) list for a corresponding L1 report configuration identifier i may be explicitly or implicitly configured/indicated to the UE by the base station. For example, the corresponding indication information may be defined and transmitted. Alternatively, based on a corresponding L1 report configuration/sub-configuration list included in a corresponding RRC message, the UE may be made to process the information in consideration thereof. Through the size information, the corresponding UE can easily process the information considering the size applied in the corresponding L1 report configuration.

As another example, if a size (e.g., the number of bits) of an information field for indicating an activation/deactivation state of a corresponding L1 report in a corresponding L1 report configuration (e.g., ltm-CSI-ReportConfig) list to which a MAC CE is applied has a fixed value (e.g., 4), and a size (e.g., the number of bits) of a field for indicating activation/deactivation of a sub-configuration x in a corresponding L1 report sub-configuration (e.g., ltm-CSI-subReportConfig) list for a corresponding L1 report configuration identifier i has a fixed value (e.g., 8), then if a bit/field for indicating an activation/deactivation state of a corresponding L1 report in an i-th L1 report configuration list is set to activation (e.g., 1), i,x bits/fields, for example, i,x bits/fields where x=0, 1, 2, 3, 4, 5, 6, 7, for corresponding i and x may be made to exist. If a bit/field for indicating an activation/deactivation state of a corresponding L1 report in the i-th L1 report configuration list is set to deactivation (e.g., 0), i,x bits/fields, for example, i,x bits/fields where x=0, 1, 2, 3, 4, 5, 6, 7, for corresponding i and x may be made not to exist. For a deactivated L1 report configuration, since all sub-configurations are also deactivated, the corresponding bits/fields may be made not to exist.

As another example, if the number of corresponding L1 report sub-configurations (having a corresponding report configuration type (e.g., event-triggered)) in a corresponding L1 report sub-configuration list included in an RRC message is less than a corresponding fixed value (e.g., x+1), the UE may be made to ignore the corresponding i,x-th bit/field. Through the fixed value, it is possible to prevent the UE from performing an unnecessary operation.

As another example, an i,j-th bit of an information field for indicating whether a sub-configuration included in a corresponding L1 report configuration is in an activation/deactivation state may be determined according to an ascending order (or descending order) of information for identifying an i-th configured corresponding L1 report configuration with respect to i and j, and an ascending order (or descending order) of information for identifying a j-th configured L1 report sub-configuration. If a bit of the corresponding field is set to 0, the corresponding configuration may be deactivated. If a bit of the corresponding field is set to 1, the corresponding configuration may be activated.

As another example, the MAC CE may include one or more pieces of information among information (e.g., a 1-bit A/D field) for indicating whether a corresponding L1 report configuration/sub-configuration for a corresponding candidate/serving cell/configuration is in an activation/deactivation state, and information for indicating an activation/deactivation state of a corresponding L1 report in a corresponding L1 report configuration/sub-configuration list to which the MAC CE is applied.

As another example, for information for indicating whether a corresponding L1 report configuration/sub-configuration for a corresponding candidate/serving cell/configuration is in an activation/deactivation state, an i-th bit of the corresponding field may be determined according to an ascending order (or descending order) of configured candidate cell/configuration identification information. For example, a first (e.g., i=0) bit may be for a candidate cell/configuration having the lowest corresponding candidate cell/configuration identification information. A second (i=1) bit may be for a candidate cell/configuration having the second lowest corresponding candidate cell/configuration identification information. (Or, the first (e.g., i=0) bit may be for a cell/configuration of a serving cell. The second (i=1) bit may be for a candidate cell/configuration having the lowest corresponding candidate cell/configuration identification information excluding the serving cell.)

As another example, if information for indicating whether a corresponding L1 report configuration/sub-configuration for a corresponding candidate/serving cell/configuration is in an activation/deactivation state has a fixed value (e.g., 4), and a size (e.g., the number of bits) of a field for indicating activation/deactivation of a configuration x in a corresponding L1 report configuration list for a corresponding candidate/serving cell/configuration identifier i has a fixed value (e.g., 8), then if a bit/field for indicating an activation/deactivation state of a corresponding L1 report in an i-th candidate/serving cell/configuration is set to activation (e.g., 1), i,x bits/fields, for example, i,x bits/fields where x=0, 1, 2, 3, 4, 5, 6, 7, for corresponding i and x may be made to exist. If a bit/field for indicating an activation/deactivation state of a corresponding L1 report in the i-th corresponding candidate/serving cell/configuration is set to deactivation (e.g., 0), i,x bits/fields, for example, i,x bits/fields where x=0, 1, 2, 3, 4, 5, 6, 7, for corresponding i and x may be made not to exist. For a deactivated candidate cell/configuration, since all corresponding L1 report configurations are also deactivated, the corresponding bits/fields may be made not to exist.

As another example, if the number of corresponding L1 measurement sub-configurations in a corresponding candidate cell/configuration list included in an RRC message is less than a corresponding fixed value (e.g., x+1), the UE may be made to ignore the corresponding i,x-th bit/field. Through the fixed value, it is possible to prevent the UE from performing an unnecessary operation.

As another example, information for indicating whether a corresponding L1 report configuration/sub-configuration for a corresponding candidate/serving cell/configuration to which a MAC CE is applied is in an activation/deactivation state may have a fixed value. If the number of corresponding candidate cells/configurations in a corresponding candidate cell/configuration list included in an RRC message is less than a corresponding fixed value (e.g., i+1), the UE may be made to ignore the corresponding i-th bit/field. Through the fixed value, it is possible to prevent the UE from performing an unnecessary operation.

As another example, the MAC CE may be provided through one or more MAC CEs having different LCIDs/eLCIDs. For example, a MAC CE having 8 bits of information for indicating whether to activate a corresponding L1 report configuration for a corresponding candidate cell/configuration, and a MAC CE having 16/32 bits of information for indicating whether to activate a corresponding L1 report configuration for a corresponding candidate cell/configuration may be defined and used. Alternatively, a MAC CE having a specific number of bits of information for indicating whether to activate a corresponding L1 report configuration for a candidate cell/configuration, and a MAC CE having another specific number of bits of information for indicating whether to activate a corresponding L1 report configuration for a candidate cell/configuration may be defined and used. Alternatively, a MAC CE having a specific number of bits for the corresponding number of bits, and a MAC CE having another specific number of bits for the corresponding number of bits may be defined and used. Alternatively, a MAC CE for indicating whether to activate a corresponding L1 report configuration for a candidate cell/configuration, and a MAC CE for indicating whether a corresponding CSI/SSB/CSI-RS resource/resource set (and/or sub-CSI/SSB/CSI-RS resource/resource set) is in an activation/deactivation state may be included. Alternatively, a MAC CE for indicating whether to activate a corresponding L1 report configuration for a candidate cell/configuration, and a MAC CE for indicating whether a corresponding L1 report sub-configuration included in/associated with a corresponding L1 report configuration for a corresponding candidate cell/configuration is activated may be included. Alternatively, a MAC CE for indicating whether to activate a corresponding L1 report configuration for one candidate cell/configuration, and a MAC CE for indicating whether to activate a corresponding L1 report configuration for one or more candidate cells/configurations may be included.

As another example, the MAC CE may be made to have a variable size. Through the variable size, it is possible to indicate activation/deactivation for one or more resources/resource sets.

As another example, the MAC CE may be made to have a fixed size. Through the fixed size, it is possible to reduce processing overhead in the UE and the base station.

Hereinafter, other embodiments according to the present disclosure will be described.

As an example, a resource configuration for L1 measurement may be included as a lower-level information element (directly located) within an LTM configuration as common information for an LTM serving cell/configuration or one or more LTM candidate cells/configurations. Through the configuration, an SSB resource/resource set configuration (e.g., LTM-SSB-ResourceSet) or a CSI-RS resource/resource set configuration (e.g., LTM-CSI-RS-ResourceSet) for L1 measurement for one or more LTM candidate cells/configurations can be effectively configured.

A LTM CSI resource configuration (e.g., LTM-CSI-ResourceConfig) for L1 measurement may include one or more pieces of information among information for identifying a corresponding CSI resource configuration, corresponding SSB resource set configuration information, corresponding CSI-RS resource set configuration information, a corresponding SSB resource set list, or a corresponding CSI-RS resource set list.

The SSB resource set configuration may include information on an SSB index (or SS/PBCH Block Resource indicator (SSBRI)) list and an LTM candidate configuration identification information (LTM-CandidateId) list included in the resource set.

The CSI-RS resource set configuration may include information on a CSI-RS index (or CSI-RS resource indicator (CRI)) list and an LTM candidate configuration identification information (LTM-CandidateId) list included in the resource set.

The CSI-RS resource associated with the resource set configuration may be a CSI-RS resource different from a typical non-zero-power (NZP) CSI-RS resource reported through L1 signaling (e.g., UCI, PUCCH, PUSCH). Alternatively, the CSI-RS resource associated with the resource set configuration may be an NZP (non-zero-power) CSI-RS resource for MAC CE-based measurement reporting signaling.

As another example, a resource configuration for L1 measurement may be included as a lower-level information element (directly located) within an LTM candidate cell/configuration (e.g., LTM-Candidate). Through the configuration, an (NZP) CSI-RS resource (e.g., LTM-CSI-RS-ResourceConfig)/resource set configuration (e.g., LTM-CSI-RS-ResourceSet) for L1 measurement may be effectively configured for each candidate cell.

For the L1 measurement, the LTM CSI resource configuration included in the candidate cell/configuration may include at least one of information for identifying the CSI resource configuration, a CSI-RS resource type (e.g., periodic, semi-persistent), CSI-RS resource set configuration information, or a CSI-RS resource set list.

The CSI-RS resource set configuration may include information on a CSI-RS index (or CSI-RS resource indicator (CRI)) list included in the resource set. The CSI-RS resource set list may include one or more pieces of (NZP) CSI-RS resource set identification information.

The CSI-RS resource associated with the resource set may be a CSI-RS resource different from a typical non-zero-power (NZP) CSI-RS resource reported through L1 signaling (e.g., UCI, PUCCH, PUSCH). Alternatively, the CSI-RS resource associated with the resource set may be an NZP (non-zero-power) CSI-RS resource for MAC CE-based measurement reporting signaling.

As another example, in order to reduce CSI/SSB/CSI-RS resources targeted for L1 measurement, a sub/subset/part of the CSI/SSB/CSI-RS resource configuration may be distinguished.

For example, one CSI-RS resource configuration may be divided into one or more CSI-RS subset resource configurations. CSI-RS resources included in each CSI-RS subset resource may be composed of CSI-RS resources included in the CSI-RS resource configuration. CSI-RS resources included in each CSI-RS subset resource may be composed of CSI-RS resources that are exclusive/non-overlapping between the respective subsets. For example, a specific/arbitrary CSI-RS resource may be included in/associated with only one CSI-RS subset resource.

Alternatively, CSI-RS resources included in each CSI-RS subset resource may be composed of CSI-RS resources that are included overlappingly between the respective subsets. For example, a specific/arbitrary CSI-RS resource may be included in/associated with one or more CSI-RS subset resources.

The CSI-RS subset resource configuration (and/or the CSI-RS subset resource set configuration) may be indicated to the UE. For convenience of explanation, this will be referred to as a sub CSI-RS resource configuration/resource set configuration hereinafter. The term is for convenience of explanation and may be replaced with any other name.

The sub CSI-RS resource configuration/resource set configuration may include one or more of information for identifying the sub CSI-RS resource configuration/resource set configuration (or a list of information for identifying the sub CSI-RS resource configuration/resource set configuration), a sub CSI-RS resource type (e.g., periodic, semi-persistent), information for identifying a CSI-RS resource/resource configuration in which the sub CSI-RS resource configuration/resource set configuration is included/with which the sub CSI-RS resource configuration/resource set configuration is associated, sub CSI-RS resource set configuration information, sub CSI-RS resource set list information, and a sub CSI-RS parameter. The sub CSI-RS resource set list may include one or more of a list of information (e.g., NZP-CSI-RS-ResourceSetId) for identifying an NZP-CSI-RS resource set, a list of information (e.g., SSB-ResourceSetId) for identifying an SSB resource set, and a corresponding UL/DL BWP-ID. The sub CSI-RS parameter may represent a parameter used for a corresponding L1 report configuration (e.g., an LTM CSI report (sub) configuration). For example, the sub CSI-RS parameter may include one or more of an antenna port subset and associated parameters related to the corresponding sub-configuration (e.g., codebook configuration information (CodebookConfig) applicable to ports indicated by a port subset indicator, a port subset indicator indicating a (sub) set of CSI-RS antenna ports used for CSI calculation in the corresponding sub-configuration, a power offset (when powerControl Offset is configured in NZP CSI-RS resources in the resource set for channel measurement associated with the CSI-ReportConfig, the power offset of PDSCH EPRE to NZP CSI-RS EPRE is equal to powerControlOffset-powerOffset), a list of NZP CSI-RS resources for the sub-configuration (list of NZP CSI RS resources for the sub-configuration that is a (sub) set of NZP CSI-RS resource(s) of the CSI-RS resource set for channel measurement associated with the sub-configuration in the CSI report configuration), and an NZP CSI-RS resource/resource set list for the sub-configuration.

As another example, in order to reduce CSI/SSB/CSI-RS resources targeted for L1 measurement, a sub/subset/part of the CSI/SSB/CSI-RS resource set configuration may be distinguished.

For example, one CSI-RS resource set configuration may be divided into one or more CSI-RS subset resource set configurations. Each CSI-RS subset resource set configuration may be configured with CSI-RS resources/indexes included in the CSI-RS resource set configuration. Each CSI-RS subset resource set configuration may include information on a CSI-RS index (or CSI-RS resource indicator (CRI)) list included in the resource set. CSI-RS index(es) included in each CSI-RS subset resource set may be composed of CSI-RS index(es) that are exclusive/non-overlapping between the respective subset resource set configurations. For example, a specific/arbitrary CSI-RS index may be included in/associated with only one CSI-RS subset resource set.

Alternatively, CSI-RS index(es) included in each CSI-RS subset resource set may be configured to be included overlappingly between the respective subsets. For example, a specific/arbitrary CSI-RS index(es) may be included in/associated with one or more CSI-RS subset resource sets.

The CSI-RS subset resource set configuration may be indicated to the UE. For convenience of explanation, this will be referred to as a sub CSI-RS resource set configuration hereinafter. The term is for convenience of explanation and may be replaced with any other name.

A sub CSI-RS resource set configuration may include one or more of information for identifying the sub CSI-RS resource set configuration (or a list of information for identifying the sub CSI-RS resource set configuration), a type (e.g., periodic, semi-persistent) of the sub CSI-RS resource set (or a resource in which a resource set is included), a list of CSI-RS indices (or CSI-RS resource indicators (CRIs)) included in the sub CSI-RS resource set, information for identifying a CSI-RS resource set in which the sub CSI-RS resource set is included/with which it is associated (e.g., NZP-CSI-RS-ResourceSetId), a list of information for identifying an NZP-CSI-RS resource set included in the sub CSI-RS resource set (e.g., NZP-CSI-RS-ResourceSetId), a list of information for identifying an SSB resource set included in the sub CSI-RS resource set (e.g., SSB-ResourceSetId), a corresponding BWP-ID, and sub CSI-RS parameters. The sub CSI-RS parameters may represent parameters used for a corresponding L1 report configuration (e.g., an LTM CSI report (sub) configuration). For example, the sub CSI-RS resource set configuration may include one or more of an antenna port subset and associated parameters related to the corresponding sub-configuration (e.g., codebook configuration information (CodebookConfig) applicable to ports indicated by a port subset indicator, a port subset indicator indicating a (sub) set of CSI-RS antenna ports used for CSI calculation in the corresponding sub-configuration, power offset (when powerControlOffset is configured in NZP CSI-RS resources in the resource set for channel measurement associated with the CSI-ReportConfig, the power offset of PDSCH EPRE to NZP CSI-RS EPRE is equal to powerControlOffset-powerOffset), a list of NZP CSI-RS resources for the sub-configuration that is a (sub) set of NZP CSI-RS resource(s) of the CSI-RS resource set for channel measurement associated with the sub-configuration in the CSI report configuration, and a list of NZP CSI-RS resources/resource sets for the sub-configuration.

As another example, a sub CSI/SSB/CSI-RS resource/resource set configuration may be indicated to the UE. For example, if a sub CSI/SSB/CSI-RS resource/resource set configuration associated with an L1 measurement has L sub-configurations, the base station may indicate to the UE a list of information for identifying M sub-configurations among the L configured sub-configurations in the CSI-RS subset resource/resource set configuration associated with the L1 measurement. The indication information may be indicated through a bitmap/bitstring having a size of L or a Boolean sequence having a size of L. A bit/Boolean index/sequence for the corresponding indication information may be determined by an ascending order (or descending order) of corresponding CSI-RS subset resource/resource identification information. If the bit/Boolean is set to 1 (or 0)/True (or false)/setup/activate, the UE may setup/configure/set/store/activate the corresponding sub CSI/SSB/CSI-RS resource/resource set configuration. The UE may perform/initiate/activate the L1 measurement according to the sub CSI/SSB/CSI-RS resource/resource set configuration.

As another example, one or more CSI/SSB/CSI-RS resource/resource set configurations may be indicated to the UE. For example, if there are L CSI-RS resource/resource set configurations associated with a L1 measurement, the base station may indicate to the UE a list of information for identifying M configurations among the L CSI-RS resource/resource set configurations associated with the L1 measurement. The indication information may be indicated through a bitmap/bitstring having a size of L or a Boolean sequence having a size of L. A bit/Boolean index/sequence for the indication information may be determined by an ascending order (or descending order) of CSI-RS subset resource/resource identification information. If the bit/Boolean is set to 1 (or 0)/True (or false)/setup/activate, the UE may setup/configure/set/store/activate the CSI/SSB/CSI-RS resource/resource set configuration. The UE may perform/initiate/activate the L1 measurement according to the CSI/SSB/CSI-RS resource/resource set configuration.

A base station may configure an RRC-connected UE to perform L1 beam level measurement for LTM candidate cells. The base station may configure the UE to report L1 measurement results according to an L1 event-triggered beam level measurement configuration. Measurement results may be used to indicate, to a serving base station, L1 beam level measurement results of a serving cell and/or a candidate cell when a corresponding L1 event trigger condition is satisfied.

The base station may configure to report measurement results per SS/PBCH block and an SS/PBCH block(s) resource indicator (SSBRI) based on an SSB (SS/PBCH block(s)). The base station may configure to report measurement results per CSI-RS resource and a CSI-RS resource indicator (CRI) based on CSI-RS resources.

The base station may indicate/configure a configuration to the UE through an RRC message (e.g., RRC reconfiguration). For example, a L1 measurement may be indicated/configured by defining parameters within an LTM CSI resource configuration (LTM-CSI-ResourceConfig).

As another example, the L1 measurement may be indicated/configured by defining parameters within an LTM CSI report configuration (LTM-CSI-ReportConfig) included in a CSI measurement configuration. To this end, the CSI measurement configuration may be made usable for configuring an L1 report through a MAC CE. And/or the CSI measurement configuration may include one or more of an LTM CSI resource configuration, an L1 measurement resource configuration, LTM CSI resource/resource set configuration identification information, or L1 measurement resource/resource set configuration identification information used for an event-triggered measurement report by a MAC CE. For reference, a typical CSI measurement configuration was an information element used for configuring channel state information reports on a PUCCH or a PUSCH triggered by a DCI in a serving cell.

As another example, L1 CSI report configuration information separate from an LTM CSI report configuration (LTM-CSI-ReportConfig) included in a CSI measurement configuration may be defined, and parameters may be defined within the information to indicate/configure the configuration. As described above, the typical CSI measurement configuration was an information element used for configuring channel state information reports on a PUCCH or a PUSCH triggered by a DCI in a serving cell. Therefore, in order to distinguish an L1 reporting configuration through a MAC CE, it is necessary to define a L1 measurement configuration information element. The L1 measurement configuration information element may be configured as an information element included in a serving cell configuration (e.g., ServingCellConfig).

As another example, an LTM/L1 CSI sub-report configuration may be defined within an LTM/L1 CSI report configuration, and parameters may be defined within the information to indicate/configure the configuration.

As another example, an LTM/L1 CSI report configuration (or an LTM/L1 CSI sub-report configuration) may include one or more of information for identifying a L1 report configuration (e.g., LTM-CSI-ReportConfigId), information for identifying a resource configuration for an L1 measurement (e.g., LTM-CSI-ResourceConfigId), a report configuration type (e.g., ltm-ReportConfigType), LTM/L1 CSI resource identification information used for an event-triggered measurement report by a MAC CE, LTM/L1 CSI resource set configuration identification information used for an event-triggered measurement report by a MAC CE, and information for indicating whether to periodically transmit the corresponding event-triggered measurement report, as lower-level components (directly positioned).

As another example, an LTM/L1 CSI report configuration (or an LTM/L1 CSI sub-report configuration) may restrict its report configuration type to be configured as event-triggered only. Through the configuration, the UE may be made to operate by distinguishing a L1 reporting for LTM.

As another example, an LTM/L1 CSI report configuration (or an LTM/L1 CSI sub-report configuration) may indicate a parameter for the number of measurement reports (e.g., report amount) for an event-triggered report type, thereby allowing the UE to limit the number of corresponding L1 reports. L1 reporting may be initiated/performed when the number of transmitted L1 reports is less than the number. A corresponding periodic reporting timer may be started when the number of transmitted L1 reports is less than the number.

As another example, a UE may obtain L1 beam level measurement results through measurement of one or more beams configured by a base station. The UE may apply L1 filtering before using measured results for reporting criterion evaluation and measurement reporting. A MAC entity may perform reporting criterion evaluation based on L1 filtered measurement results received from lower layers. For an L1 beam level event-triggered measurement report, the base station may configure an SSB/CSI-RS as an event evaluation RS type and L1-RSRP as a trigger quantity. An LTM report configuration for L1 measurement may be associated with one single resource configuration. The single resource set may be applied for one or more candidate cells/configurations.

As another example, candidate cell/configuration information (e.g., LTM-Candidate) may include resource configuration information (e.g., ltm-NZP-CSI-RS-ResourceConfig) or resource set configuration information (e.g., ltm-NZP-CSI-RS-ResourceSet) for a corresponding L1 measurement. An L1 measurement resource and the candidate cell/configuration may be associated.

As another example, one or more single L1 report configurations may be configured for a candidate cell/configuration.

As another example, one or more CSI-RS resources may be associated with an L1 report configuration.

As another example, one or more CSI-RS resources may be associated with the CSI report configuration.

As described above, through the present disclosure, L1 measurement and reporting triggered through dynamic MAC CE signaling to support an LTM procedure can be effectively reduced.

Above, the method of controlling activation/deactivation operations for detailed elements related to the LTM operation of the UE using the MAC CE and an example of indicating whether to activate reporting have been described.

The UE and base station configurations described below may perform each of the above-described embodiments or any combination of the embodiments. The UE and the base station below are composed of components such as a memory, a processor, an antenna, and a signal processor, and each operation is controlled by the processor and may be performed according to the components such as the memory, the antenna, and the signal processor.

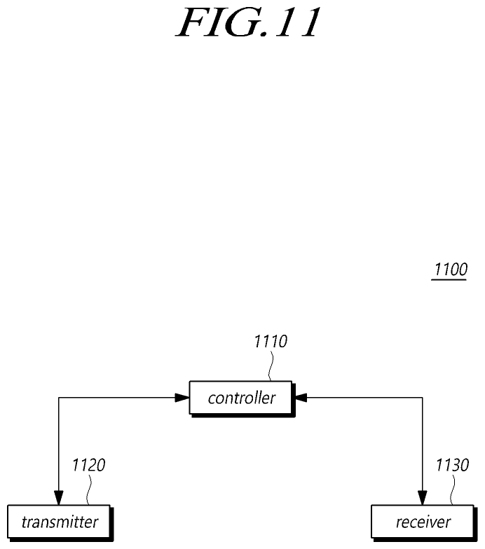

FIG. 11 is a block diagram illustrating a UE according to an embodiment.

Referring to FIG. 11, a UE 1100 performing a mobility operation includes a receiver 1130 receiving, from a base station, an RRC message including semi-persistent CSI-RS resource set information, and a controller 1110 configuring a semi-persistent CSI-RS resource set for one or more candidate cells. The receiver 1130 receives a MAC CE indicating whether to activate an L1/L2 triggered mobility (LTM) CSI resource configuration including the semi-persistent CSI-RS resource set.

In accordance with an embodiment, the receiver 1130 may receive configuration information necessary for performing an LTM operation through an upper layer message. As an example, the receiver 1130 may receive LTM configuration information (e.g., LTM-Config) from the base station through an RRC connection reconfiguration message. The controller 1110 may store/configure the LTM configuration information in the UE and perform the above-described mobility operation at a lower level.

For the LTM operation, the receiver 1130 may receive semi-persistent CSI-RS resource set information included in the RRC message. As an example, the RRC message may be an RRC connection reconfiguration message, but is not limited thereto.

One or more pieces of semi-persistent CSI-RS resource set information may be included in the RRC message. The semi-persistent CSI-RS resource set information may be set for each candidate cell for the LTM operation. Alternatively, one or more pieces of semi-persistent CSI-RS resource set information may be set for each CSI resource.

For example, the RRC message may include the above-described LTM configuration information. The LTM configuration information may include several lower-level information elements, and may include an LTM CSI resource configuration (LTM CSI ResourceConfig) as one lower-level information element. One or more LTM CSI resource configurations may be included in the LTM configuration information in the form of a list.

The LTM CSI resource configuration may include at least one of CSI resource configuration identification information, SSB resource set information, or semi-persistent CSI-RS resource set information. Accordingly, one or more pieces of semi-persistent CSI-RS resource set information may be included for each LTM CSI resource configuration. The SSB resource set information may include information on resources related to SSB transmission for channel quality measurement in a corresponding LTM operation. The SSB resource set information may include one or more pieces of SSB resource information. The semi-persistent CSI-RS resource set information includes CSI-RS resource information measured by the UE to perform the LTM operation.

The CSI resource configuration identification information is identification information allocated for each LTM CSI resource configuration. For example, the CSI resource configuration identification information may refer to ID information, such as a CSI ResourceConfig ID, for distinguishing and recognizing each LTM CSI resource configuration.

The controller 1110 may store information of the received RRC message in the UE and configure parameters for performing the LTM operation. The controller 1110 may measure CSI-RS quality for the LTM operation using the configured semi-persistent CSI-RS resource set.

As described above, one or more CSI resource configurations may be configured in the UE for one or more candidate cells. Although the LTM operation is performed for fast handover and signal quality maintenance, unnecessary power waste may occur if the UE measures and determines signal quality for all candidate cells and/or configured CSI resource configurations.

Accordingly, when receiving and configuring the semi-persistent CSI-RS resource set in the UE through the RRC message, the controller 1110 may configure the semi-persistent CSI-RS resource set in a deactivated state. While only a target candidate cell is in an activated state, configurations for the remaining candidate cells may be configured in a deactivated state in terms of UE operation, thereby preventing unnecessary signal measurement and monitoring.

The receiver 1130 receives a MAC CE indicating whether to activate the configured LTM CSI resource configuration from the base station. As described above, the LTM CSI resource configuration is configured in the UE in a deactivated state when the RRC message is received. Accordingly, in order to activate the LTM CSI resource configuration configured in the UE, the UE may receive indication information from the base station. Alternatively, only one LTM CSI resource configuration or one piece of semi-persistent CSI resource set information may be configured in an activated state upon initial configuration, and the remaining resource configurations or resource set information may be configured in a deactivated state.

Accordingly, the controller 1110 may perform a subsequent activation or deactivation operation based on a MAC CE transmitted by the base station.

For example, the MAC CE may include at least one of 1-bit A/D field information indicating activation or deactivation, one or more pieces of CSI resource configuration identification information, or TCI state identification information on a TCI state used as a QCL source in the semi-persistent CSI-RS resource set.

An activation unit using the MAC CE may be set in units of the LTM CSI resource configuration rather than being set for each semi-persistent CSI-RS resource set. Accordingly, the MAC CE may include a 1-bit A/D field for indicating whether to activate and CSI resource configuration identification information associated with the corresponding A/D field. Accordingly, whether to activate for each CSI resource configuration identification information may be indicated by the MAC CE.

In addition, the MAC CE may further include TCI state identification information for indicating a TCI state used as a QCL source in the semi-persistent CSI-RS resource set.

In the case of the semi-persistent CSI-RS resource set, a plurality of resource sets may exist, and if these are individually indicated, there may be a problem in terms of channel measurement and MAC CE overhead. In consideration of the above, whether to activate may be indicated for each LTM CSI resource configuration including one or more semi-persistent CSI-RS resource sets.

To this end, the MAC CE may include CSI resource configuration identification information capable of identifying and indicating the LTM CSI resource configuration, and an A/D field may be set to correspond to each piece of CSI resource configuration identification information. Through the A/D field, the base station may indicate activation/deactivation for two or more CSI resource configurations with a single MAC CE.

The CSI resource configuration identification information of the MAC CE may be set identically to or in association with identification information (e.g., a CSI resource configuration ID) included as a lower-level information element of the LTM CSI resource configuration included in the RRC message.

In particular, in the case of a semi-persistent operation, since activation and deactivation operations are performed, a plurality of activation indications through the MAC CE may occur, and in the case of an indication in units of a resource set according to high-speed movement of the UE, frequent changes or system overhead may become serious.

Therefore, in the present disclosure, by indicating whether to activate in units of the LTM CSI resource configuration through the MAC CE, the semi-persistent CSI-RS resource set included in the LTM CSI resource configuration may be indirectly indicated.

In addition, the controller 1110 controls the overall operation of the UE 1100 according to dynamic MAC CE signaling for supporting an LTM procedure necessary for performing the present disclosure described above.

The transmitter 1120 and the receiver 1130 are used to transmit and receive signals, messages, or data necessary for performing the present disclosure described above to and from the base station.

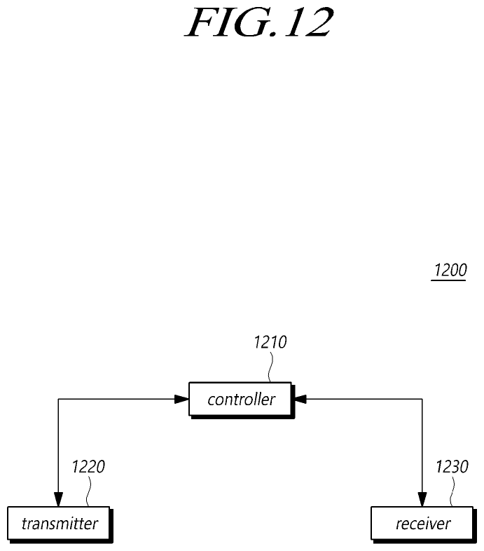

FIG. 12 is a block diagram illustrating a base station according to an embodiment.

Referring to FIG. 12, a base station 1200 controlling a mobility operation of a UE may include a transmitter 1220 that transmits, to the UE, an RRC message including semi-persistent CSI-RS resource set information and transmits a MAC CE indicating whether to activate an L1/L2 triggered mobility (LTM) CSI resource configuration including a semi-persistent CSI-RS resource set for one or more candidate cells configured in the UE, and a controller 1210 that controls operations of the transmitter 1220 and a receiver 1230.

The transmitter 1220 may transmit configuration information necessary for performing an LTM operation through a higher-layer message. As an example, the transmitter 1220 may transmit LTM configuration information (e.g., LTM-Config) through an RRC connection reconfiguration message. The UE may store/configure the LTM configuration information in the UE and perform the mobility operation at a lower level described above.

For the LTM operation, the transmitter 1220 may transmit semi-persistent CSI-RS resource set information included in the RRC message to the UE. As an example, the RRC message may be an RRC connection reconfiguration message, but is not limited thereto.

One or more pieces of semi-persistent CSI-RS resource set information may be included in the RRC message. In addition, the semi-persistent CSI-RS resource set information may be set for each candidate cell for the LTM operation. Alternatively, one or more pieces of semi-persistent CSI-RS resource set information may be set for each CSI resource.

For example, the RRC message may include the LTM configuration information. The LTM configuration information may include several lower-level information elements and may include an LTM CSI resource configuration (LTM CSI ResourceConfig) as one lower-level information element. One or more LTM CSI resource configurations may be included in the LTM configuration information in a list form.

The LTM CSI resource configuration may include at least one of CSI resource configuration identification information, SSB resource set information, or semi-persistent CSI-RS resource set information. Accordingly, one or more pieces of semi-persistent CSI-RS resource set information may be included for each LTM CSI resource configuration. The SSB resource set information may include information on resources related to SSB transmission for channel quality measurement in a corresponding LTM operation. The SSB resource set information may include one or more pieces of SSB resource information. The semi-persistent CSI-RS resource set information includes CSI-RS resource information measured by the UE to perform the LTM operation.

The CSI resource configuration identification information is identification information allocated for each LTM CSI resource configuration. For example, the CSI resource configuration identification information may refer to ID information, such as a CSI ResourceConfig ID, for identifying and recognizing each LTM CSI resource configuration.

The UE may store information of the received RRC message in the UE and configure parameters for performing the LTM operation. The UE may measure CSI-RS quality for the LTM operation by using the configured semi-persistent CSI-RS resource set.

One or more CSI resource configurations for one or more candidate cells may be configured in the UE. When receiving a semi-persistent CSI-RS resource set through an RRC message and configuring the semi-persistent CSI-RS resource set in the UE, the UE may configure the semi-persistent CSI-RS resource set in a deactivated state. By setting only a target candidate cell to an activated state while configuring configurations for remaining candidate cells in a deactivated state in terms of UE operation, unnecessary signal measurement and monitoring can be prevented.

The transmitter 1220 of the base station transmits, to the UE, a MAC CE indicating whether to activate an LTM CSI resource configuration configured in the UE. The LTM CSI resource configuration is configured in the UE in a deactivated state when the RRC message is received. Accordingly, to activate the LTM CSI resource configuration configured in the UE, the base station transmits indication information to the UE. Alternatively, the UE may be configured such that only one LTM CSI resource configuration or one piece of semi-persistent CSI resource set information is configured in an activated state during initial configuration, and remaining resource configurations or resource set information are configured in a deactivated state. Accordingly, the UE may perform a subsequent activation or deactivation operation based on the MAC CE transmitted by the base station.

For example, the MAC CE may include at least one of 1-bit A/D field information indicating activation or deactivation, one or more pieces of CSI resource configuration identification information, or TCI state identification information on a TCI state used as a QCL source in the semi-persistent CSI-RS resource set.

An activation unit using the MAC CE may be set in units of LTM CSI resource configurations, rather than being set for each semi-persistent CSI-RS resource set. Accordingly, the MAC CE may include a 1-bit A/D field for indicating whether to activate and CSI resource configuration identification information associated with the corresponding A/D field. Accordingly, whether to activate for each piece of CSI resource configuration identification information may be indicated by the MAC CE.

In addition, the MAC CE may further include TCI state identification information for indicating a TCI state used as a QCL source in the semi-persistent CSI-RS resource set.

A plurality of semi-persistent CSI-RS resource sets may exist, and if they are individually indicated, there may be problems in terms of channel measurement and MAC CE overhead. In consideration of the above, whether to activate may be indicated for each LTM CSI resource configuration including one or more semi-persistent CSI-RS resource sets.

To this end, the MAC CE may include CSI resource configuration identification information capable of identifying and indicating the LTM CSI resource configuration, and an A/D field may be set correspondingly for each piece of CSI resource configuration identification information. Through the A/D field, the base station may indicate activation/deactivation for two or more CSI resource configurations with one MAC CE.

The CSI resource configuration identification information of the MAC CE may be set to be the same as or associated with identification information (e.g., CSI resource configuration ID) included as a lower-level information element of the LTM CSI resource configuration included in the RRC message.

The controller 1210 controls overall operations of the base station 1200 according to dynamic MAC CE signaling for supporting the LTM procedure necessary for performing the present disclosure described above.

The transmitter 1220 and the receiver 1230 are used to transmit/receive signals, messages, or data necessary for performing the present disclosure described above to/from the UE.

The embodiments described above may be supported by the standard documents disclosed in at least one of the radio access systems such as IEEE 802, 3GPP, and 3GPP2. That is, the steps, configurations, and parts, which have not been described in the present embodiments, may be supported by the above-mentioned standard documents for clarifying the technical concept of the disclosure. In addition, all terms disclosed herein may be described by the standard documents set forth above.

The above-described embodiments may be implemented by any of various means. For example, the present embodiments may be implemented as hardware, firmware, software, or a combination thereof.

In the case of implementation by hardware, the method according to the present embodiments may be implemented as at least one of an application specific integrated circuit (ASIC), a digital signal processor (DSP), a digital signal processing device (DSPD), a programmable logic device (PLD), a field programmable gate array (FPGA), a processor, a controller, a microcontroller, or a microprocessor.

In the case of implementation by firmware or software, the method according to the present embodiments may be implemented in the form of an apparatus, a procedure, or a function for performing the functions or operations described above. Software code may be stored in a memory unit, and may be driven by the processor. The memory unit may be provided inside or outside the processor, and may exchange data with the processor by any of various well-known means.

In addition, the terms “system”, “processor”, “controller”, “component”, “module”, “interface”, “model”, “unit”, and the like may generally mean computer-related entity hardware, a combination of hardware and software, software, or running software. For example, the above-described components may be, but are not limited to, a process driven by a processor, a processor, a controller, a control processor, an entity, an execution thread, a program and/or a computer. For example, both the application that is running in a controller or a processor and the controller or the processor may be components. One or more components may be provided in a process and/or an execution thread, and the components may be provided in a single device (e.g., a system, a computing device, etc.), or may be distributed over two or more devices.

The above embodiments of the present disclosure have been described only for illustrative purposes, and those skilled in the art will appreciate that various modifications and changes may be made thereto without departing from the scope and spirit of the disclosure. Further, the embodiments of the disclosure are not intended to limit, but are intended to illustrate the technical idea of the disclosure, and therefore the scope of the technical idea of the disclosure is not limited by these embodiments. The scope of the present disclosure shall be construed on the basis of the accompanying claims in such a manner that all of the technical ideas included within the scope equivalent to the claims belong to the present disclosure.

What is claimed is:

1. A method of performing a mobility operation by a user equipment (UE), the method comprising:
receiving, from a base station, an radio resource control (RRC) message including semi-persistent channel state information reference signal (CSI-RS) resource set information;
configuring the semi-persistent CSI-RS resource set for one or more candidate cells; and
receiving a medium access control control element (MAC CE) indicating whether to activate an L1/L2 triggered mobility (LTM) CSI resource configuration including the semi-persistent CSI-RS resource set.

2. The method of claim 1, wherein the configuring the semi-persistent CSI-RS resource set comprises configuration the semi-persistent CSI-RS resource set in a deactivated state.

3. The method of claim 1, wherein the MAC CE includes at least one of 1-bit activation/deactivation (A/D) field information indicating activation or deactivation, one or more pieces of CSI resource configuration identification information, or TCI state identification information on a transmission configuration indicator (TCI) state used as a quasi-co-location (QCL) source in the semi-persistent CSI-RS resource set.

4. The method of claim 3, wherein the one or more pieces of CSI resource configuration identification information are information indicating the LTM CSI resource configuration, the LTM CSI resource configuration being a lower-level information element of an LTM configuration included in the RRC message.

5. The method of claim 4, wherein the LTM CSI resource configuration includes at least one of the CSI resource configuration identification information, synchronization signal block (SSB) resource set information, or the semi-persistent CSI-RS resource set information.

6. A method of controlling a mobility operation of a user equipment (UE) by a base station, the method comprising:
transmitting, to the UE, an radio resource control (RRC) message including semi-persistent channel state information reference signal (CSI-RS) resource set information; and
transmitting a medium access control control element (MAC CE) indicating whether to activate an L1/L2 triggered mobility (LTM) CSI resource configuration including the semi-persistent CSI-RS resource set for one or more candidate cells configured in the UE.

7. The method of claim 6, wherein the semi-persistent CSI-RS resource set is initially configured in the UE in a deactivated state according to the transmission of the RRC message.

8. The method of claim 6, wherein the MAC CE includes at least one of 1-bit activation/deactivation (A/D) field information indicating activation or deactivation, one or more pieces of CSI resource configuration identification information, or transmission configuration indicator (TCI) state identification information on a TCI state used as a quasi-co-location (QCL) source in the semi-persistent CSI-RS resource set.

9. The method of claim 8, wherein the one or more pieces of CSI resource configuration identification information are information indicating the LTM CSI resource configuration, the LTM CSI resource configuration being a lower-level information element of an LTM configuration included in the RRC message.

10. The method of claim 9, wherein the LTM CSI resource configuration includes at least one of the CSI resource configuration identification information, synchronization signal block (SSB) resource set information, or the semi-persistent CSI-RS resource set information.

11. A user equipment (UE) performing a mobility operation, the UE comprising:
a receiver configured to receive, from a base station, an radio resource control (RRC) message including semi-persistent channel state information reference signal (CSI-RS) resource set information; and
a controller configured to configure the semi-persistent CSI-RS resource set for one or more candidate cells,
wherein the receiver is configured to receive a medium access control control element (MAC CE) indicating whether to activate an L1/L2 triggered mobility (LTM) CSI resource configuration including the semi-persistent CSI-RS resource set.

12. The UE of claim 11, wherein the controller is configured to configure the semi-persistent CSI-RS resource set in a deactivated state according to reception of the RRC message.

13. The UE of claim 11, wherein the MAC CE includes at least one of 1-bit activation/deactivation (A/D) field information indicating activation or deactivation, one or more pieces of CSI resource configuration identification information, or transmission configuration indicator (TCI) state identification information on a TCI state used as a quasi-co-location (QCL) source in the semi-persistent CSI-RS resource set.

14. The UE of claim 13, wherein the one or more pieces of CSI resource configuration identification information are information indicating the LTM CSI resource configuration which is a lower-level information element of an LTM configuration included in the RRC message.

15. The UE of claim 14, wherein the LTM CSI resource configuration includes at least one of the CSI resource configuration identification information, synchronization signal block (SSB) resource set information, or the semi-persistent CSI-RS resource set information.
